(19) United States
(12) Patent Application Publication
(10) Pub. No.: US 2006/0190266 A1
(43) Pub. Date: Aug. 24, 2006

(54) Home information appliance system

(75) Inventors: Toru Tanigawa, Osaka (JP); Shusaku Okamoto, Osaka (JP); Tomonobu Naruoka, Kanagawa (JP); Yoshihiko Matsukawa, Nara (JP); Osamu Yamada, Nara (JP)

Correspondence Address: GREGORY A. STOBBS, 5445 CORPORATE DRIVE, SUITE 400, TROY, MI, 48098, US

(73) Assignee: MATSUSHITA ELECTRIC INDUSTRIAL CO., LTD., Osaka (JP)

(21) Appl. No.: 11/398,069

(22) Filed: Apr. 5, 2006

Related U.S. Application Data
(63) Continuation of application No. PCT/JP05/00983, filed on Jan. 26, 2005.

(30) Foreign Application Priority Data
Jan. 29, 2004 (JP) 2004-020745

(51) Int. Cl. G10L 11/00

(52) U.S. Cl. 704/273

(57) ABSTRACT

When a home electric appliance detects and identifies an article to be handled by the home electric appliance, the home electric appliance executes handling of the article in conformity with a control program corresponding to the specified article. When the control program corresponding to the specified article is not present, the home electric appliance downloads the corresponding control program from a program distribution means through a network, and further sends information on the article to home electric appliances having possibility to operate the article. Upon reception of information from the home electric appliance, the home electric appliances download a control program corresponding to the article from the program distribution means through the network if the control program corresponding to the article is not present.

This is a continuation application of International Application No. PCT/JP2005/000983, filed Jan. 26, 2005.

### BACKGROUND OF THE INVENTION

The present invention relates to a home information appliance system including home electric appliances for handling articles.

Today, people are surrounded with an indefinitely large number of articles as well as a large number of home electric appliances which handle these articles. For example, the home electric appliances handling articles are exemplified by refrigerators and freezers handling food articles, and clothes washers and clothes dryers handling clothing articles. Moreover, current home electric appliances have various modes of operation corresponding to attributes of articles, so that users need to understand the attributes of articles and select the operation modes of the home electric appliances corresponding to the attributes. More particularly, the clothes washer has washing modes for clothing articles and the microwave oven has heating modes for food articles.

For saving users the trouble of selecting modes of operation of the home electric appliances, a clothes washer (system) using IC tags is disclosed in Patent Document 1 (Japanese Unexamined Patent Publication No. 2002-360968). In the system, attached to clothing articles is a tag with a method for washing the clothes (an operation mode) written, and the clothes washer reads information in the tag attached to the clothes with use of a tag reader. Then, based on the read information, the operation mode is automatically selected to wash the clothing articles. According to the system, when the clothes washer is given, for example, clothing articles impossible to wash by the clothes washer, a warning message can be issued to the user.

However, the system disclosed in Patent Document 1 has a disadvantage that clothing articles are not washable when the clothes washer does not have an operation mode program (control program) corresponding to the washing method written onto the tag. In view of the present circumstances where new articles (clothes, their materials, etc.) are being developed every day, it is desirable that the system can support newly developed articles.

For example, in Patent Document 2 (Japanese Unexamined Patent Publication No. 2003-44691), a system for updating incorporated programs in home electric appliances with use of a network is disclosed. In this system, a management center for managing new programs, home electric appliances, and terminals of users of the home electric appliances are connected through the network. When a program is updated, the management center broadcasts the information to each terminal, and in response to update requests sent from the terminals, the updated program is sent to the home electric appliances.

However, in the system in the Patent Document 2, the user of home electric appliances received program update information needs to determine whether an updated program is necessary by herself/himself and request to sent the updated program if determined it necessary. Further, the user needs to request to send updated programs for all the home electric appliance which need to be updated. Thus, the user of home electric appliances needs to spend time and effort.

In view of these issues, an object of the present invention is to provide a home information appliance system capable of maintaining home electric appliances which handle articles in the state constantly capable of handling handling-target articles without requiring involvement of users.

### SUMMARY OF THE INVENTION

In order to accomplish the object, the present invention is structured as shown below.

According to a first aspect of the present invention, there is provided a home information appliance system, comprising:

a plurality of home electric appliances having various control programs corresponding to respective attributes of a plurality of articles, handling the articles in conformity with the control programs, and connected to each other by fixed lines and/or radio;

a program distribution means capable of distributing the control programs to the respective home electric appliances; and

a network capable of connecting the respective home electric appliances and the program distribution means to each other, the respective home electric appliances comprising:

a storage means having a related appliances database including information on mutual association among the plurality of the home electric appliances;

an article detection section for detecting an article to be handled by the pertinent home electric appliance among a plurality of the articles;

an information detection means for detecting information on the article detected by the article detection section to identify the article;

a program download means for downloading a control program corresponding to the identified article from the program distribution means through the network when the corresponding control program is not present; and

a control means for controlling respective operations of the storage means, the information detection means, and the program download means, and executing handling of the identified article in conformity with the control program corresponding to the identified article based on an identification result of the handling-target article, while making a reference to the information on mutual association among a plurality of the home electric appliances in the related appliances database to distribute information on the identified article to other home electric appliances related to the pertinent home electric appliance downloaded the program, wherein

upon reception of information on the article distributed from one of a plurality of the home electric appliances, the control means of other home electric appliances determine whether or not a control program corresponding to the pertinent article is present, and controls the program download means to download the corresponding control program from the program distribution means through the network if the control program is not present.

According to a second aspect of the present invention, there is provided a home information appliance system, comprising:

a plurality of home electric appliances having various control programs corresponding to respective attributes of a plurality of articles and handling the articles in conformity with the control programs;

a server connected to the respective home electric appliances by fixed lines and/or radio;

a program distribution means capable of distributing the control programs to the respective home electric appliances; and

a network capable of connecting the server and the program distribution means to each other,

the respective home electric appliances comprising:

an article detection section for detecting an article to be handled by the pertinent home electric appliance among a plurality of the articles;

an information detection means for detecting information on an article detected by the article detection section to identify the article; and

a control means for executing handling of the article in conformity with the control program corresponding to the article based on an identification result of the article, and requesting the server to download the control program corresponding to the identified article if the corresponding control program is not present,

the server comprising:

a storage means having a related appliances database including information on mutual relation among a plurality of the home electric appliances;

a program download means for, in response to download requests from the respective home electric appliances, downloading the control program, which is for the home electric appliance requested the download and which corresponds to the identified article, from the program distribution means through the network; and

a control means for distributing the downloaded control program to the home electric appliance requested the download, and making a reference to the related appliances database to distribute information on the identified article to home electric appliances related to the home electric appliance requested the download, wherein

upon reception of information on the article distributed from one of a plurality of the home electric appliances, the control means of other home electric appliances determine whether or not a control program corresponding to the pertinent article is present, and request the server to download the corresponding control program if the control program is not present.

According to the constitution, when a home electric appliance detects and identifies an article to be handled by the home electric appliance, the home electric appliance executes handling of the article in conformity with a control program corresponding to the identified article. For example, if the home electric appliance is a clothes washer and the article is a clothing article, the solution amount, the washing time, the number of rinsing times, etc., are set based on the control program corresponding to the clothing article and the clothing article is washed accordingly.

If the control program corresponding to the identified article is not present, the home electric appliance downloads the corresponding control program by the program distribution means through the network, and further transmits the information on the article to the home electric appliance(s) having possibility to operate the article.

Upon reception of the information from the home electric appliance, a home electric appliance downloads a control program corresponding to the article by the program distribution means through the network if the control program is not present.

Thus, in the home information appliance system, when an article to be handled by a home electric appliance is identified, i.e., when a user of the home electric appliance attempts to operate the home electric appliance to execute handling of the article, a program corresponding to the article can be downloaded from the program distribution means where necessary, and further the control program can be downloaded in advance to home electric appliance(s) having possibility to handle the article. The control program is obviously a program necessary for the home electric appliance to execute handling of the article without the user to determine the necessity of the control program. As a result, the home electric appliance is put in the state capable of handling the handling-target article without requiring involvement of the user of the home electric appliance.

### BRIEF DESCRIPTION OF THE DRAWINGS

These and other aspects and features of the present invention will become clear from the following description taken in conjunction with the preferred embodiments thereof with reference to the accompanying drawings, in which:

FIG. 1 is a block diagram showing one example of the overall constitution of a home information appliance system in a first embodiment of the present invention;

FIG. 2 is a block diagram showing one example of the overall constitution of a home information appliance system in a second embodiment of the present invention;

FIG. 3A is an explanatory view showing an article information database before being updated;

FIG. 3B is an explanatory view showing the article information database after being updated;

FIG. 4 is a view showing information in a related appliances database possessed by a clothes washer in the first embodiment in the form of a table;

FIG. 5 is a view showing information in a related appliances database possessed by a house server in the second embodiment in the form of a table;

FIG. 6 is a flowchart showing the processing by the home information appliance system in the first embodiment;

FIG. 7 is a flowchart showing the processing by the home information appliance system in the first embodiment;

FIG. 8 is a flowchart showing the processing by the home information appliance system in the second embodiment;

FIG. 9 is a flowchart showing the processing by the home information appliance system in the second embodiment;

FIG. 10 is a view showing one example of the overall constitution of a home information appliance system in a third embodiment of the present invention;

FIG. 11 is a view showing a related appliances database possessed by a house server in the third embodiment;

FIG. 12 is a flowchart showing the processing by the home information appliance system in the third embodiment;

FIG. 13 a flowchart showing the processing by the home information appliance system in the third embodiment;

FIG. 14A is a view showing information before being updated in an article information database possessed by the house server in the third embodiment in the form of a table;

FIG. 14B is a view showing information after being updated in the article information database possessed by the house server in the third embodiment in the form of a table;

FIG. 15 is a view showing a clothes washer and a clothes iron with tag readers attached thereto;

FIG. 16 is a view showing one example of information recorded on a tag;

FIG. 17 is a view showing one example of a program for washing a clothing article;

FIG. 18 is a view showing one example of programs distributed by a program distribution apparatus;

FIG. 19 is a block diagram showing one example of the overall constitution of a home information appliance system in a modified example of the first or the second embodiment; and

FIG. 20 is a view showing an example of an article information database possessed by each home electric appliance in the form of a table.

### DETAILED DESCRIPTION OF THE PREFERRED EMBODIMENTS

Before the description of the present invention proceeds, it is to be noted that like parts are designated by like reference numerals throughout the accompanying drawings.

Description is hereinbelow give of various aspects of the present invention before the embodiments of the present invention are described in detail with reference to the drawings.

According to a first aspect of the present invention, there is provided a home information appliance system, comprising:

a plurality of home electric appliances having various control programs corresponding to respective attributes of a plurality of articles, handling the articles in conformity with the control programs, and connected to each other by fixed lines and/or radio;

a program distribution means capable of distributing the control programs to the respective home electric appliances; and

a network capable of connecting the respective home electric appliances and the program distribution means to each other,

the respective home electric appliances comprising:

a storage means having a related appliances database including information on mutual association among the plurality of the home electric appliances;

an article detection section for detecting an article to be handled by the pertinent home electric appliance among a plurality of the articles;

an information detection means for detecting information on the article detected by the article detection section to identify the article;

a program download means for downloading a control program corresponding to the identified article from the program distribution means through the network when the corresponding control program is not present; and

a control means for controlling respective operations of the storage means, the information detection means, and the program download means, and executing handling of the identified article in conformity with the control program corresponding to the identified article based on an identification result of the handling-target article, while making a reference to the information on mutual association among a plurality of the home electric appliances in the related appliances database to distribute information on the identified article to other home electric appliances related to the pertinent home electric appliance downloaded the program, wherein

upon reception of information on the article distributed from one of a plurality of the home electric appliances, the control means of other home electric appliances determine whether or not a control program corresponding to the pertinent article is present, and controls the program download means to download the corresponding control program from the program distribution means through the network if the control program is not present.

According to a second aspect of the present invention, there is provided a home information appliance system, comprising:

a plurality of home electric appliances having various control programs corresponding to respective attributes of a plurality of articles and handling the articles in conformity with the control programs;

a server connected to the respective home electric appliances by fixed lines and/or radio;

a program distribution means capable of distributing the control programs to the respective home electric appliances; and

a network capable of connecting the server and the program distribution means to each other,

the respective home electric appliances comprising:

an article detection section for detecting an article to be handled by the pertinent home electric appliance among a plurality of the articles;

an information detection means for detecting information on an article detected by the article detection section to identify the article; and

a control means for executing handling of the article in conformity with the control program corresponding to the article based on an identification result of the article, and requesting the server to download the control program corresponding to the identified article if the corresponding control program is not present,

the server comprising:

a storage means having a related appliances database including information on mutual relation among a plurality of the home electric appliances;

a program download means for, in response to download requests from the respective home electric appliances, downloading the control program, which is for the home electric appliance requested the download and which corresponds to the identified article, from the program distribution means through the network; and

a control means for distributing the downloaded control program to the home electric appliance requested the download, and making a reference to the related appliances database to distribute information on the identified article to home electric appliances related to the home electric appliance requested the download, wherein

upon reception of information on the article distributed from one of a plurality of the home electric appliances, the control means of other home electric appliances determine whether or not a control program corresponding to the pertinent article is present, and request the server to download the corresponding control program if the control program is not present.

According to a third aspect of the present invention, there is provided a home information appliance system as defined in the first aspect, wherein

one of the home electric appliances is a clothes washer,

the clothes washer has:

an article detection section for detecting clothing articles contained in a laundry basket for containing unwashed clothing articles;

an information detection means for detecting information on a clothing article detected by the article detection section to identify the clothing article; and

a communication means for providing information on the identified clothing article to the clothes washer through communication, and

upon reception of information on the article provided by the laundry basket, the control means of the clothes washer determines whether or not a control program corresponding to the pertinent article is present, and requests the server to download the control program if the control program is not present.

According to a fourth aspect of the present invention, there is provided a home information appliance system as defined in the second aspect, wherein

one of the home electric appliances is a clothes washer,

the clothes washer has:

an article detection section for detecting clothing articles contained in a laundry basket for containing unwashed clothing articles;

an information detection means for detecting information on a clothing article detected by the article detection section to identify the clothing article; and

a communication means for providing information on the identified clothing article to the clothes washer through communication, and

upon reception of information on the article provided by the laundry basket, the control means of the clothes washer determines whether or not a control program corresponding to the pertinent article is present, and requests the server to download the control program if the control program is not present.

Hereinbelow, the embodiments of the present invention will be described in detail with reference to the drawings.

### FIRST EMBODIMENT

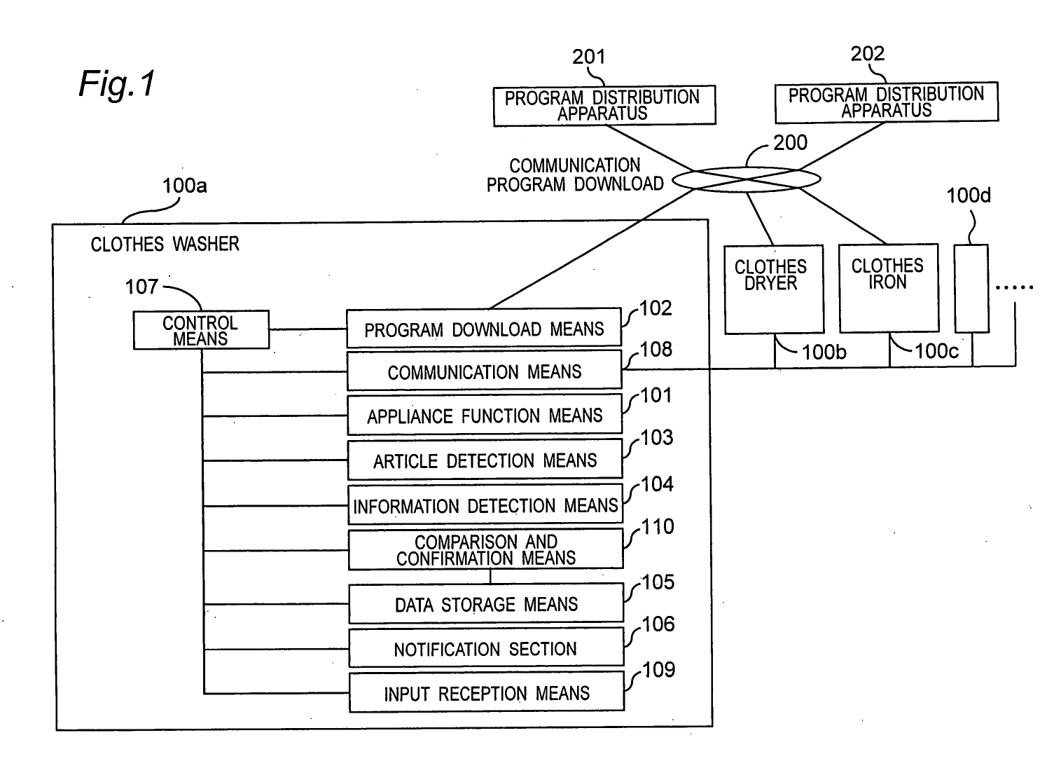

FIG. 1 is a block diagram showing one example of the overall constitution of a home information appliance system in a first embodiment of the present invention. The home information appliance system includes a plurality of home electric appliances 100 (a clothes washer 100a, a clothes dryer 100b, a clothes iron 100c, a refrigerator 100d, etc.) connected to a network 200 and handling articles, and when one home electric appliance 100 downloads a new control program, new control program(s) of other home electric appliances 100 related to the new control program are also downloaded where necessary. The network 200, which may be, for example, an internet, is connected to a plurality of program distribution apparatuses (e.g., servers) (as a more specific example, program distribution means stored in a server as programs) 201, 202 for distributing respective article handling programs of a plurality of kinds of home electric appliances 100. The program distribution apparatuses 201, 202 are managed by a third party organization such as manufacturers of articles to be handled by the respective home electric appliances 100, manufacturers of the respective home electric appliances 100, and consumer information centers. The program distribution apparatuses 201, 202 distribute control programs corresponding to new articles to be handled increasing every day and updated control programs. Herein, the respective home electric appliances 100 (100a, 100b, 100c, 100d in FIG. 1) are connected to each other by fixed lines and/or radio (Local Area Network or LAN).

The respective home electric appliance 100 include an appliance function means 101, a program download means 102, an article detection section 103, an information detection means 104, a data storage means 105, a notification section 106, a communication means 108 for communication on the LAN, an input reception means 109 for receiving inputs of operation modes and the like from users of home electric appliances, a comparison and confirmation means 110, and a control-means 107 for controlling these respective means.

The appliance function means 101 is a means to fulfill functions peculiar to the home electric appliance 100. If the home electric appliance 100 is, for example, a clothes washer 100a, the appliance function means 101 is a means to execute washing, rinsing, and dewatering of clothing articles and is composed of appliance units for executing these operations, and hardware and software for operating and controlling these appliance units. Also, if home electric appliance 100d is, for example, an refrigerator, the appliance function means 101 is a means to execute refrigeration and freezing of food articles (management of container temperatures, and the like), and is composed of appliance units for executing these operations, and hardware and software for operating and controlling these appliance units.

The article detection section 103 is an apparatus for detecting articles which require handling by the home electric appliance 100. More specifically, the article detection section 103 is constituted of a monitoring camera, a tag reader, or the like attached to the home electric appliance 100. The monitoring camera is to detect the presence of articles by camera images, and in the clothes washer 100a and the refrigerator 100d, the monitoring camera picks up images of articles when the articles are respectively put in a drum of the clothes washer 100a or a cabinet of the refrigerator 100d and detects the presence of the articles separately and independently.

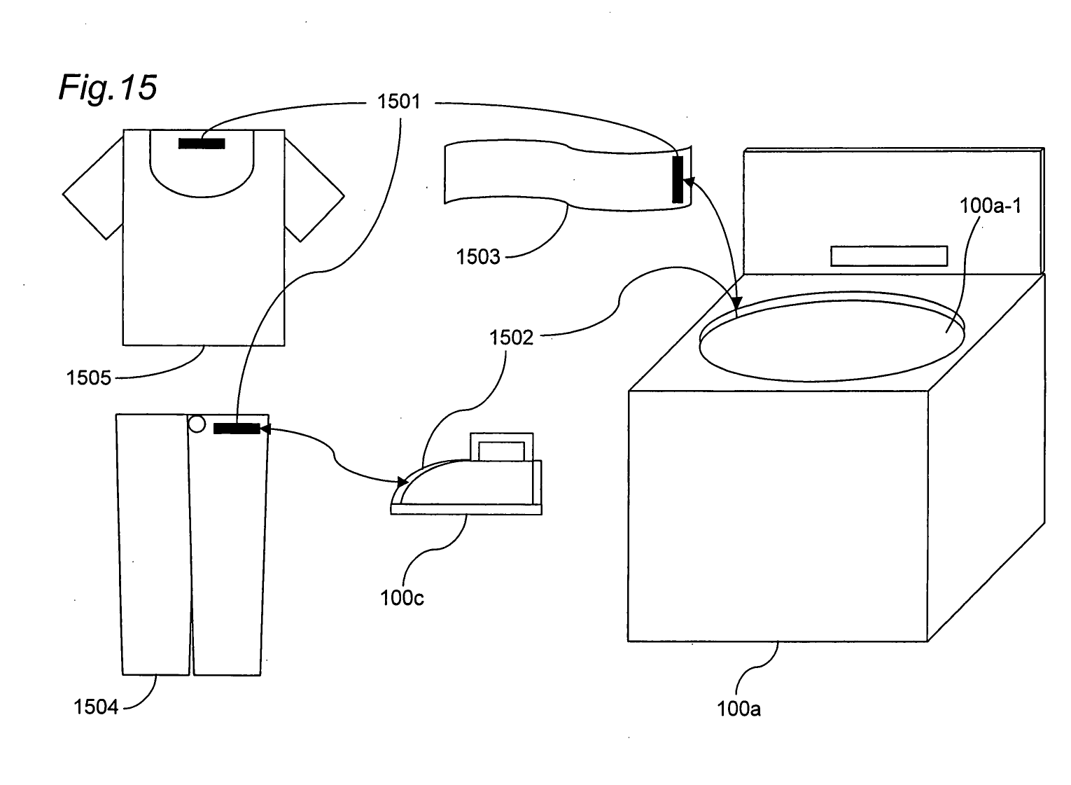

FIG. 15 herein shows an example of using a tag reader as the article detection section 103. In the case of the clothes washer 100a, a tag reader 1502 is placed inside a drum 100a-1 so that when articles (e.g., a towel 1503, a pair of trousers 1504, a shirt 1505) are put in the drum 100a-1, the tag reader 1502 can detect tags 1501 attached respectively to the articles (e.g., the towel 1503, the pair of trousers 1504, the shirt 1505). Similarly, in the case of the refrigerator 100d and the clothes dryer 100b, tag readers 1502 are placed at the respective inlets through which articles are put therein so as to allow detection of tagged articles.

Moreover, in the case of the clothes iron 100c shown in FIG. 15, a tag reader 1502 is placed on the top end portion of the clothes iron 100c so that immediately before the use of the clothes iron 100c, tagged articles (e.g., the towel 1503, the pair of trousers 1504, the shirt 1505) can be detected respectively by the tag reader 1502.

The information detection means 104 is a means to detect information of an article detected by the article detection section 103 to identify the article. If the article detection section 103 is a monitoring camera, the information detection means 104 have only to process a camera image to identity the article. For example, by reading characters on a tab (tag) containing the manufacturer, the material, or the like of the article from the camera image, the read characters on the tab (tag) containing the manufacturer, the material, or the like of the article may be compared with information regarding the relationship between the characters on the tab (tag) containing the manufacturer, the material, or the like of the article and the article, the information being pre-registered on a database which is possessed inside the information detection means 104, so as to identify the article.

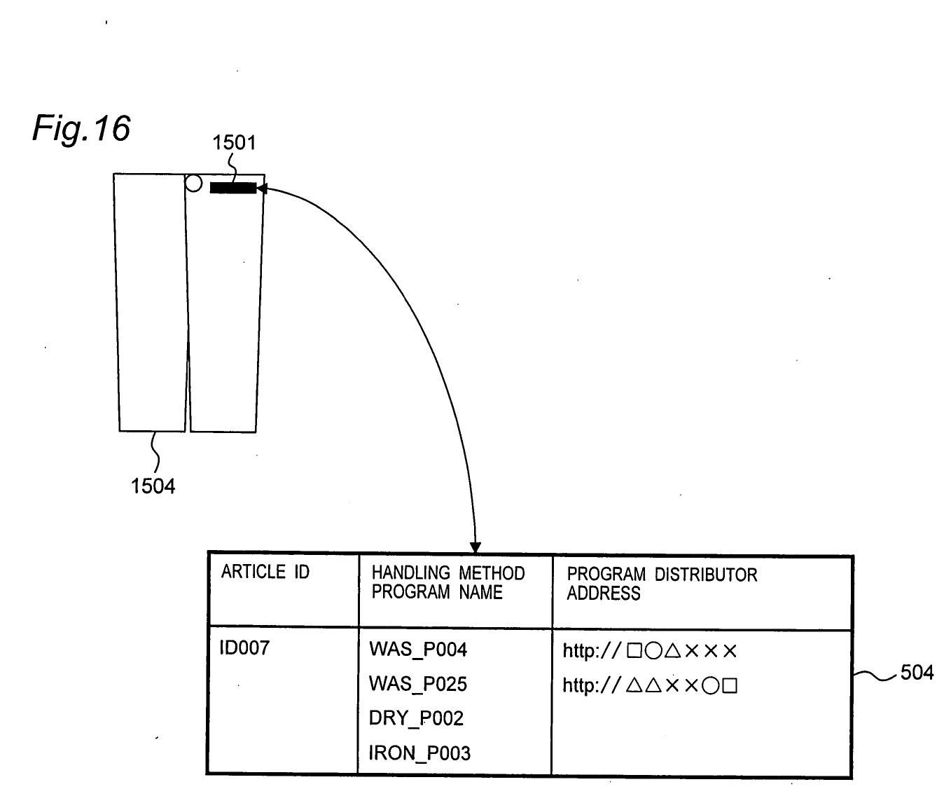

Herein, FIG. 16 shows one example of information recorded on a tag 1501 attached to an article (e.g., the pair of trousers 1504). Recorded on the tag 1501 are items including the ID of an article to which the tag 1501 is attached (e.g., ID007 in the case of the pair of trousers 1504), the name of a program necessary for operating the article (e.g., WAS_P004 in the case of the pair of trousers 1504), and the address of the program distribution apparatus 201 or 202 for distributing the program to operate the article (e.g., http://.... in the case of the pair of trousers 1504).

If the article is, for example, a clothing article, other than the items covered in FIG. 16, a recommended detergent for the clothing article or information that the clothing article is a colored article dark may be recorded.

If the article detection section 103 is a tag reader, the information detection means 104 has only to compare read tag data with the information on the relationship between the tag data and the article pre-stored in the database which is possessed inside the information detection means 104 to identify the article. Attaching the tag to the article and using the article detection section 103 as a tag reader is preferable since various information regarding the article is easily accessible from the tag data.

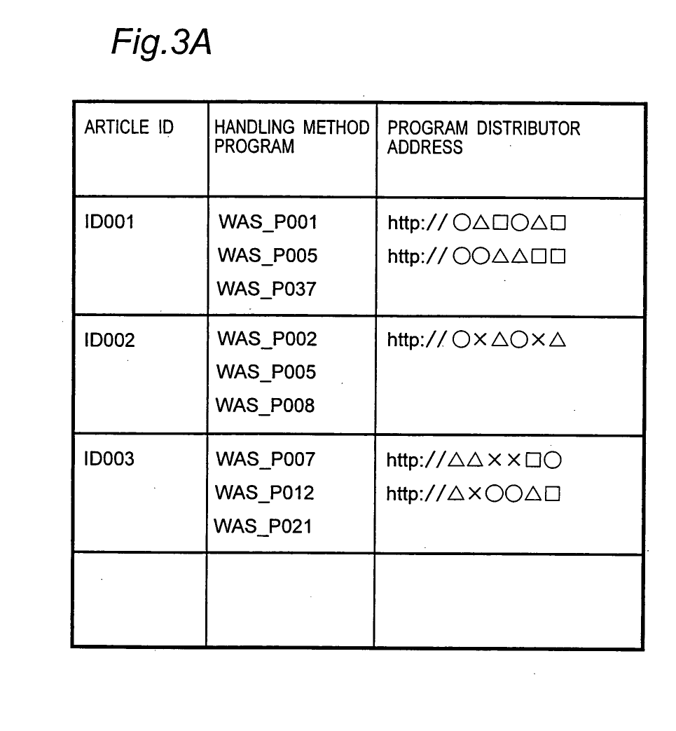

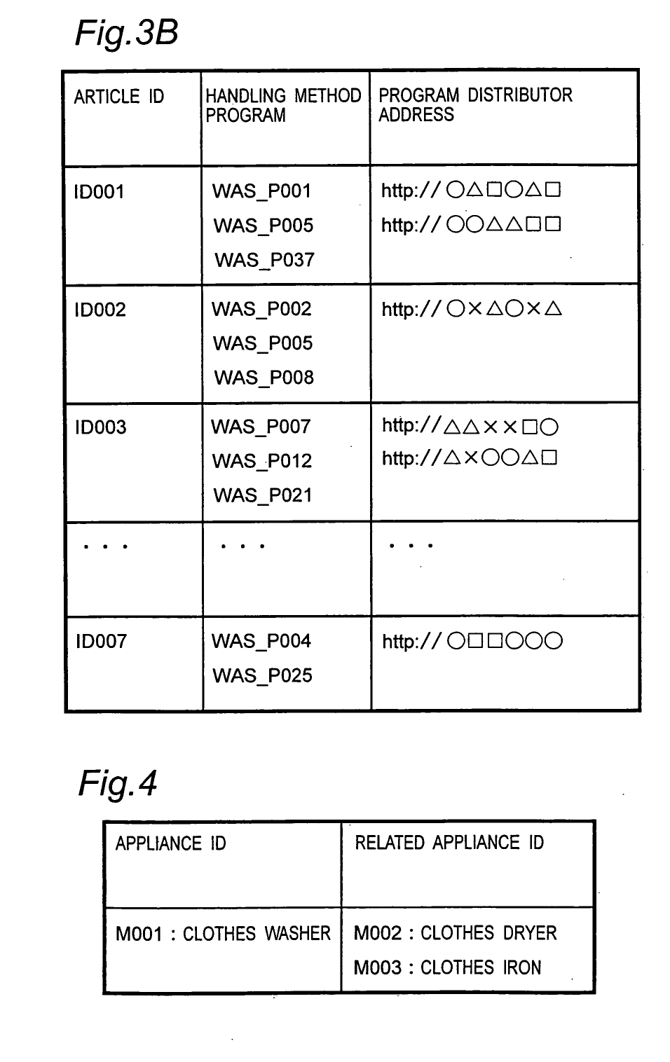

The comparison and confirmation means 110 checks whether or not the information on the article obtained by the information detection means 104 is registered on an article information database (see FIG. 3A) stored in the data storage means 105, and sends the result to the control means 107 so as to confirm whether or not the article is a new article. More particularly, if the information on the article obtained by the information detection means 104 is not recorded on the article information database, i.e., if the article is a new article, the comparison and confirmation means 110 informs the control means 107 of the fact that a new control program corresponding to the new article is necessary. If the information on the article obtained by the information detection means 104 is recorded on the article information database, the comparison and confirmation means 110 notifies the control means 107 to read a control program corresponding to (the attribute of) the identified article from the data storage means 105 based on the article information database.

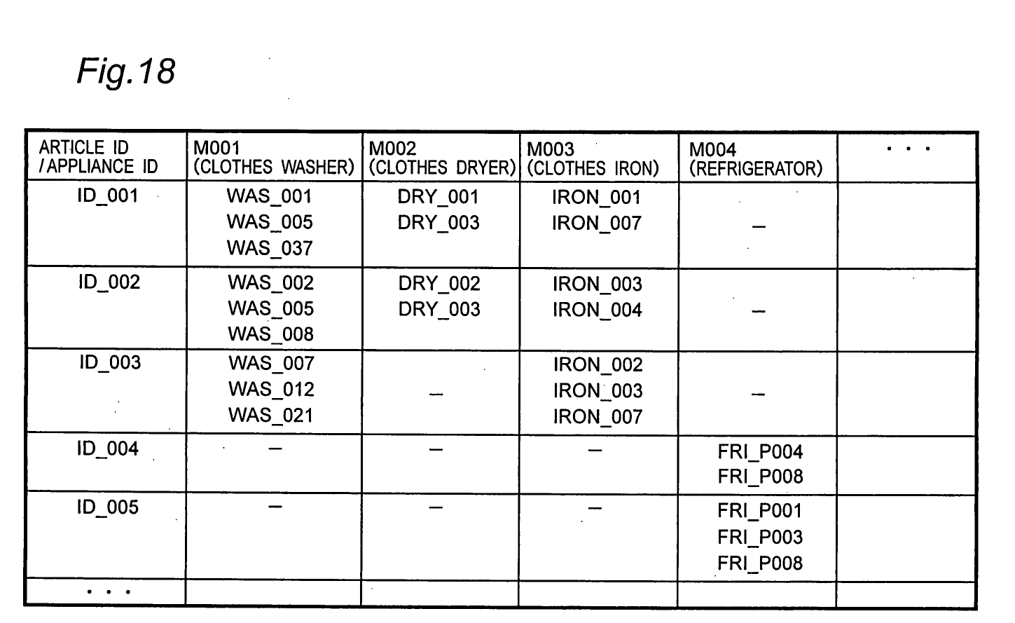

The program download means 102 is a means to download a control program from the program distribution apparatus 201 or 202 via the network 200 in response to the request from the control means 107. In this case, the control program downloaded from the program distribution apparatus 201 or 202 may be specified by the appliance ID of the home electric appliance 100, the article ID(s) handled by the home electric appliance 100, and the name of an operation method program for the home electric appliance 100 (see FIG. 3A and FIG. 18).

It is to be noted that FIG. 18 shows an example of programs distributable by the program distribution apparatus 201 or 202. The name of the handling method control program may be determined from the home electric appliance ID and the article ID(s). For example, if the home electric appliance ID is M001 (clothes washer) and the article ID is ID_001, it is indicated that three control programs, WAS_P001, WAS_P005, and WAS_P037, correspond thereto. Out of these three control programs, a control program to download may be identified by the name of the control program.

The data storage means 105 has various control programs inserted at the manufacturing of the home electric appliance 100, an article information database, and a related appliances database, and executes management of various programs and management of read and write access to various databases. As described above, a new control program downloaded by the program download means 102 is additionally stored in the data storage means 105.

Description is given of the article information database with reference to FIG. 3A. FIG. 3A is an example of the article information database possessed by the clothes washer 100a.

The article information database has information on a handling method (control program) and the program distribution apparatus (address) 201 or 202 for every article ID which can be handled by the clothes washer 100a. These information sets are obtained from, for example, tag data attached to each article and read by a tag reader serving as one example of the article detection section 103.

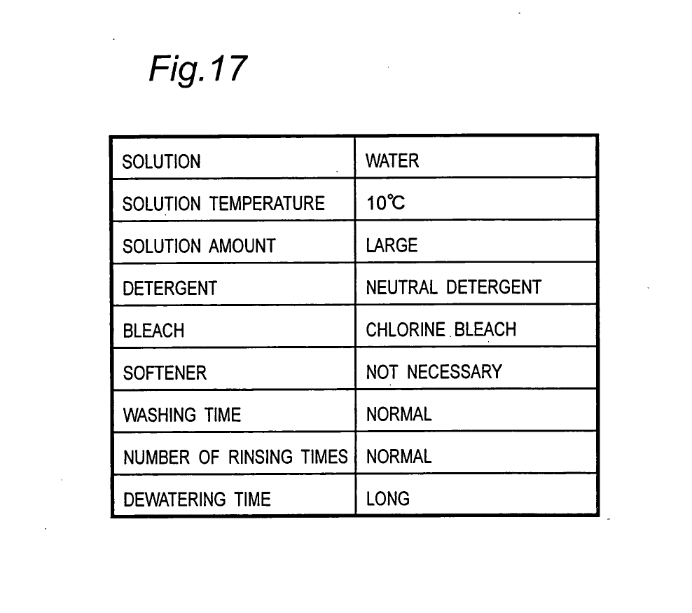

Herein, FIG. 17 shows one example of the contents of the control program WAS_P001 for executing the article handling method in the clothes washer 100a.

For example, the program WAS_P001 is to set a solution to be water, a solution temperature at 10° C., a solution amount to be large, a detergent to be a neutral detergent, a bleach to be a chlorine bleach, a softener not necessary, a washing time to be normal, a number of rinsing times to be normal, and a dewatering time to be long. The control program controls the appliance function means 101 to fulfill the solution amount, the washing time, and the number of rinsing times as set.

With respect to the related appliances database, the related home electric appliances 100 refer to the appliances which handle the same kind of articles. For example, the clothes washer 100a, the clothes dryer 100b, and the clothes iron 100c are related home electric appliances in terms of handling clothing articles, while the refrigerator 100d and the microwave oven (unshown) are related appliances in terms of handling food articles. FIG. 4 shows one example of the related appliances database, which is possessed by the clothes washer 100a of the appliance ID No. M001. As an example of information on mutual association of a plurality of home electric appliances 100, the clothes washer 100a of the appliance ID No. M001 is associated with the clothes dryer 100b of the appliance ID No. M002 and the clothes iron 100c of the appliance ID No. M003, respectively.

The control means 107 reads a control program, which is corresponding to (the attribute of) the article detected by the article detection section 103 and identified by the information detection means 104 based on the article information database of the data storage means 105, from the data storage means 105, and controls the appliance function means 101 in accordance with the control program so that the appliance function means 101 executes handling of the identified article. At the same time, if the comparison and confirmation means 110 determines that the article identified by the information detection means 104 is a new article, and further the control means 107 determines that a new control program corresponding to the new article is necessary, then the control means 107 orders the program download means 102 to download the new control program from the program distribution apparatus 201 or 202 through the network 200.

Further, if information on the article is not recorded, the control means 107 records the information on the article on the article information database of the data storage means 105 as information on a new article.

Upon download of a new control program, the control means 107 sends by the communication means 108 the information on the new article to each home electric appliance 100 associated in the related appliances database. In each home electric appliance 100 which received the information on the new article from the home electric appliance 100, the control means 107 determines whether or not a new control program corresponding to the new article is necessary, and if it is determined to be necessary, the control means 107 requests the program download means 102 to download the new control program so that before the new article is handled by each home electric appliance 100, the download of the new control program is executed in advance.

The notification section 106 is a device (more specifically, a speaker, a display device, or the like) for providing information to the user of the home electric appliance 100 by the means of voice, display, lamps, or the like, and when a new control program is downloaded for example, the information is notified to the user by the notification section 106.

The input reception means 109 is used when the user desires manual setting of the operation method for the home electric appliance 100, and is equivalent to the operation panel of the conventional home electric appliance for example.

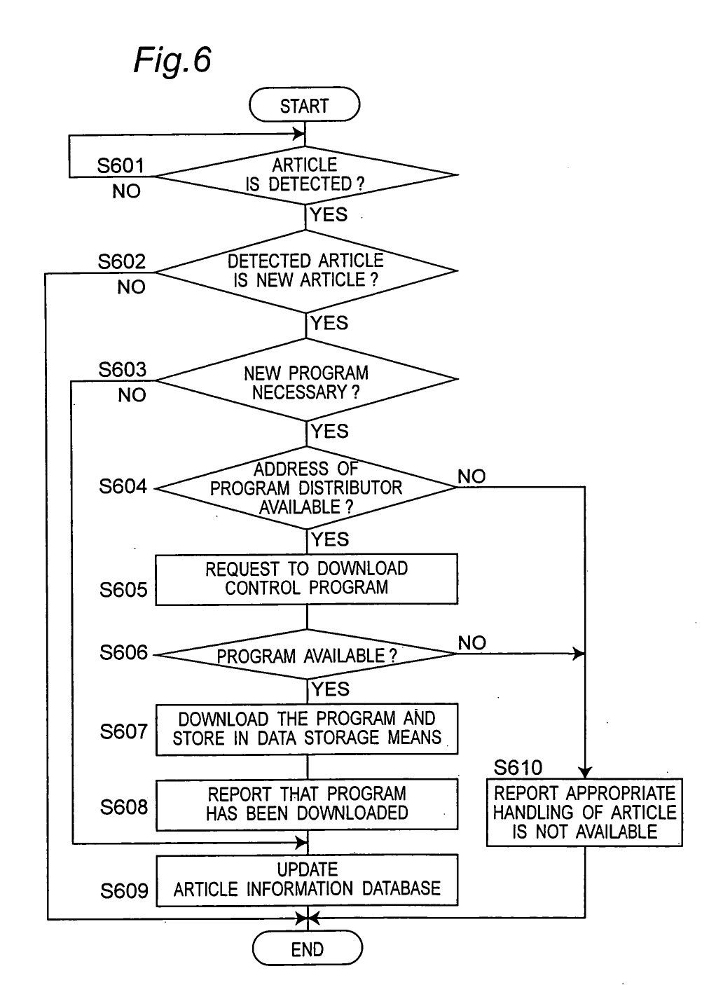

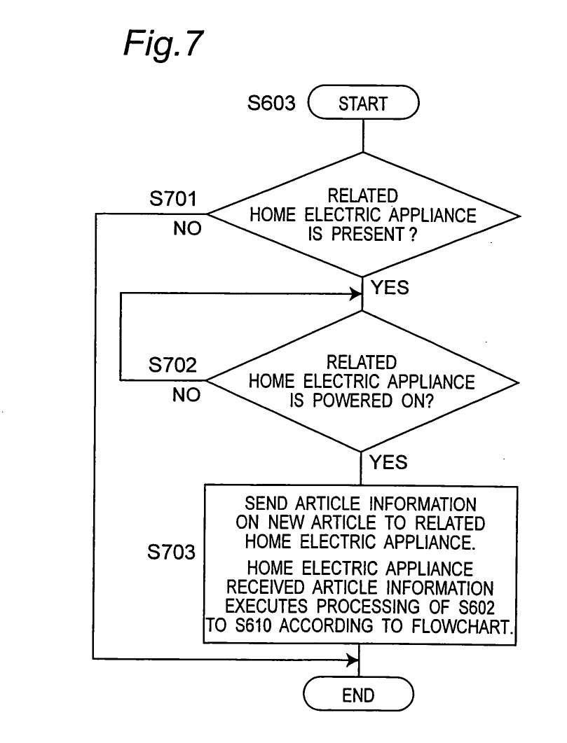

Description is now given of the processing of the home information appliance system with reference to the flowcharts shown in FIG. 6 and FIG. 7.

First, it is determined whether or not an article is detected by the article detection section 103 (step S601), and if the article is not detected, the step S601 is repeated, whereas if the article is detected, the procedure proceeds to step S602. For example, when the user of the home electric appliance 100 puts an article in the home electric appliance 100, the article detection section 103 detects the article.

The information detection means 104 obtains information on the article detected by the article detection section 103 and then identifies the article. Then, the comparison and confirmation means 110 makes a reference to the article information database of the data storage means 105 to determine whether or not information on the identified article is recorded on the article information database, i.e., whether or not the article identified by the information detection means 104 is a new article unregistered on the article information database (step S602). If the article is a new article, the procedure proceeds to step S603, whereas if the article is not a new article but an article whose information is already registered on the article information database, the processing of the home information appliance system is ended.

The control means 107 gets a handling method for the new article (a control program corresponding to the new article) from the article information database based on the information on the new article. Then, the control means 107 checks whether or not the handling method (the control program corresponding to the new article) is stored in the data storage means 105, and determines the necessity of a new program based on the result (step S603). If the control means 107 determines that the control program corresponding to the new article is not stored in the data storage means 105 and that the new control program is necessary, then the procedure proceeds to step S604. If the control program corresponding to the new article is stored in the data storage means 105, then the control means 107 determines that the new control program is not necessary and so the procedure proceeds to step S609. It is to be noted that if the control program corresponding to the new article is not stored in the data storage means 105 and if, for example, the article is new though its handling method (control program) is identical to that of the article already registered on the article information database, then the control means 107 determines that the new control program is not necessary. For example, the articles of ID001 and ID002 in FIG. 3A are washable at the same time by a program called WAS_P005. Therefore, in the case where the program called WAS_P005 is registered on the article information database as the control program for the article of ID001, and an article of ID002 is identified as a new article, the program called WAS_P005 is applicable to the article of ID002 and so the control means 107 determines that a new control program is not necessary as its handling method (control program) is identical to that of the article of ID001 already registered on the article information database. On the contrary, when an article of ID003 is identified as a new article, neither the control program for the article of ID001 nor the control program for the article of ID002 is applicable to the article, and so the control means 107 determines that a new control program is necessary, and in the meanwhile, since the article of ID003 is not supported by the handling method (control program), i.e., the washing method, for the article ID001 or ID002, the article of ID003 cannot be washed together with the article of ID001 or ID002.

When a new control program is necessary, the control means 107 determines, from the information on the new article in the article information database, whether or not information indicating the program distribution apparatus 201 or 202 is present regarding the new particle (step S604). If such information is present, the procedure proceeds to step S605, whereas if such information is not present, then the procedure proceeds to step S610.

In the case where the information indicating the program distribution apparatus 201 or 202 is present, the control means 107 orders the program download means 102 to execute download of the new control program. More specifically, under the control of the control means 107, the program download means 102 requests the program distribution apparatus 201 or 202 involving the information on the new article to download the program through the network 200 (step S605). In this case, the control program downloaded from the program distribution apparatus 201 or 202 can be specified by the home electric appliance ID, the article ID, and the name of a handling method control program (see FIG. 3A and FIG. 18).

Upon reception of the download request, the program distribution apparatus 201 or 202 determines whether or not the control program pertinent to the download request is present, and if the control program pertinent to the download request is present, a message notifying that the program is downloadable is sent to the program download means 102 through the network 200, whereas if the control program pertinent to the download request is not present or if the control program pertinent to the download request is present but the program is not downloadable, a message notifying that the program is not downloadable is sent to the program download means 102 through the network 200. Based on the information sent from the program distribution apparatus 201 or 202, the program download means 102 determines whether or not the new control program is available (step S606), and if the new control program is available, the procedure proceeds to step S607, whereas if the new control program is not available, then the procedure proceeds to step S610.

When the program download means 102 downloads the new control program, the downloaded control program is stored in the data storage means 105 (step S607). When the new control program is stored in the data storage means 105, the notification section 106 notifies that the new control program has been downloaded, and the procedure proceeds to step S609 (step S608).

In this case, the program to be downloaded is not limited to one kind (see FIG. 3A and FIG. 18). Some articles each have a plurality of handling methods. For example, in the case where the home electric appliance ID is M001 (clothes washer) and the article ID is ID_001, there are three handling methods (control programs), and these three control programs, WAS_P001, WAS_P005, and WAS_P037, are downloadable.

The control means 107 registers the information on the new article (information including the ID, the home electric appliance ID, and the handling method (control program) of the new article) obtained by the information detection means 104 on the article information database (step S609).

If the new control program is not available in the step S604 or S606, then the notification section 106 notifies the user that appropriate handling of the new article is not available. In this case, the user manually selects the operation mode of the home electric appliance 100 from the input reception means 109, cancels handling of the article, or inputs the address of different program distribution apparatus 201 or 202 to re-execute the download.

Description is now given of the processing of the control means 107 in response to detection of the new article at the above step S603 according to the flowchart shown in FIG. 7.

The control means 107 makes a reference to the related appliances database (FIG. 4) in the data storage means 105 to determine whether or not other related home electric appliance(s) 100 having possibility to handle the new article are present (step S701). If other related home electric appliance(s) 100 are not present, then the processing of the control means 107 is ended, whereas if other related home electric appliance(s) 100 are present, the procedure proceeds to step S702.

Once it is confirmed by the communication means 108 that these other related home electric appliances 100 are powered on, the procedure proceeds to step S703 (step S702).

The control 105 sends the information on the new article to the related home electric appliances 100. Upon reception of the information on the new article, the related home electric appliance(s) 100 execute the processing of S602 to S610 according to the flowchart in FIG. 6. More particularly, in the related home electric appliances 100, if the article is a new article, then its information is registered on the article information database, while if a control program for the article is necessary, the program download means 102 in each of the related home electric appliances 100 receives the download request. Then, a new control program downloaded by the program download means 102 is stored in the data storage means 105 in each of the related home electric appliances 100 (step S703).

Thus, in the home information appliance system in the first embodiment, when an article to be handled by the home electric appliance 100 is detected by the article detection section 103 and identified by the information detection means 104, i.e., when the user of the home electric appliance 100 attempts to operate the home electric appliance 100 to execute handling of the article, a control program corresponding to the article can be downloaded by the program download means 102 under the control of the control means 107 from the program distribution apparatus 201 or 202 where necessary, and stored in the data storage means 105. Since the control program is obviously a program necessary for the home electric appliance 100 to execute handling of the article without the user to determine the necessity of the control program, the home electric appliance 100 is put in the state capable of handling the handling-target article without requiring involvement of the user, and after that, the control program can be downloaded in advance to other home electric appliance(s) 100 having possibility to handle the new article by the communication means 108 under the control of the control means 107.

Thus, by putting the home electric appliance 100 in the state capable of handling the handling-target article, handling of the article can be optimized, and by downloading the control program corresponding to the new article in advance, the user of the home electric appliance 100 can use the home electric-appliance 100 without waiting for the time during which the control program is downloaded.

Moreover, only when the home electric appliance 100 is operated to execute handling of an article and a control program corresponding to the article is not present, the program is downloaded from the program distribution apparatus 201 or 202 through the network 200. Consequently, the number of times to download control programs as well as the information amount of the control programs are limited, which makes it possible to reduce communication traffic.

### SECOND EMBODIMENT

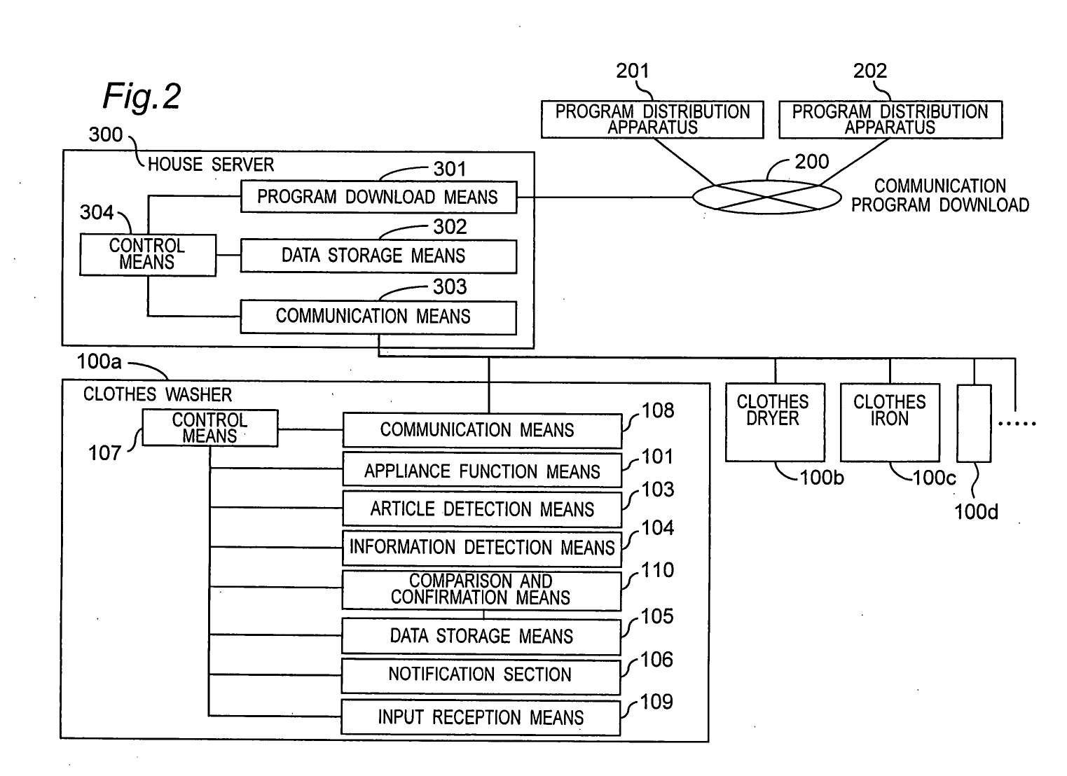

FIG. 2 is a block diagram showing one example of the overall constitution of a home information appliance system in a second embodiment of the present invention. The home information appliance system has a house server 300 so that when one of a plurality of home electric appliances 100 (including a clothes washer 100a, a refrigerator 100b, a clothes iron 100c, a refrigerator 100d, etc.) downloads a new control program, new control programs for other related home electric appliance(s) 100 can also be downloaded where necessary.

The house server 300 herein refers to a server for exercising control over the respective home electric appliances 100, and the respective home electric appliances 100 and the house server 300 are connected to each other by fixed lines and/or radio (Local Area Network or LAN).

Each of the home electric appliances 100 includes an appliance function means 101, a communication means 108 for communication on the LAN, an article detection section 103, an information detection means 104, a data storage means 105, a notification section 106, a comparison and confirmation means 110, an input reception means 109, and a control means 107 for controlling these respective means.

The house server 300 includes a program download means 301, a data storage means 302, a communication means 303, and a control means 304 for controlling these respective means 301 to 303.

More particularly, in the home information appliance system in the second embodiment, individual home electric appliances 100 do not include the program download means 102 unlike the individual home electric appliance 100 in the first embodiment, and the program download means 301 is included in the house server 300.

The appliance function means 101, the article detection section 103, the information detection means 104, the data storage means 105, the notification section 106, the comparison and confirmation means 110, and the input reception means 109 in each of the home electric appliance 100 share almost the same functions with the appliance function means 101, the article detection section 103, the information detection means 104, the data storage means 105, the notification section 106, the comparison and confirmation means 110, and the input reception means 109 in the first embodiment.

More particularly, the appliance function means 101 fulfills functions peculiar to the home electric appliance 100. The article detection section 103 detects an article which requires handling by the respective home electric appliances 100 with use of a camera, a tag reader, and the like attached to each of the home electric appliances 100. The information detection means 104 detects information on an article detected by the article detection section 103 to identify the article. The data storage means 105 has various programs relating to the pertinent home electric appliance 100 and an article information database, and manage them. The notification section 106 provides information to the user of the home electric appliance 100 by the means of voice, display, lamps, or the like. The comparison and confirmation means 110 checks whether or not the information on the article obtained by the information detection means 104 is registered on an article information database (see FIG. 3A) stored in the data storage means 105, and sends the result to the control means 107 so as to confirm whether or not the article is a new article. The input reception means 109 enables the user to manually operate the home electric appliance 100.

The program download means 301 in the house server 300 has almost the same functions as those of the program download means 102 in the first embodiment. More particularly, in response to requests from the control means 304 of the house server 300, the program download means 301 downloads control programs for the respective home electric appliances 100 from the program distribution apparatus 201 or 202 through the network 200 and temporarily stores them in the data storage means 302.

Moreover, the data storage means 302 has a related appliances database which stores information on mutually related home electric appliances 100 for a plurality of kinds of home electric appliance 100 subject to centralized control by the house server 300. The related home electric appliances 100 herein refer to appliances which handle the same kind of articles. For example, the clothes washer 100a, the clothes dryer 100b, and the clothes iron 100c are related home electric appliances in terms of handling clothing articles, while the refrigerator 100d and the microwave oven (unshown) are related appliances in terms of handling food articles.

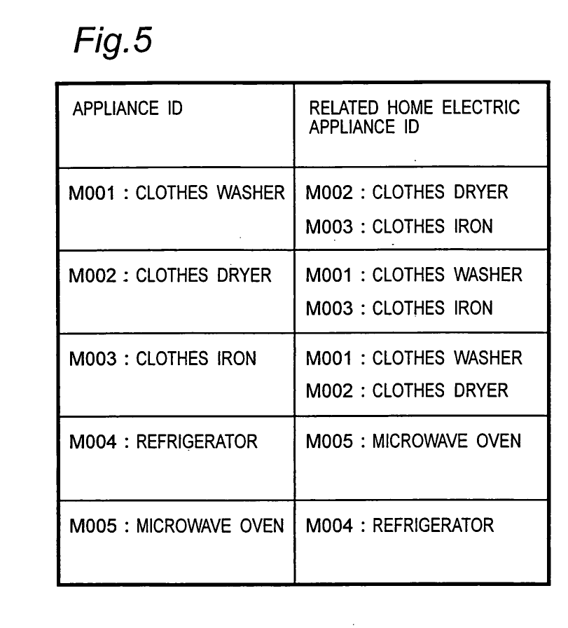

FIG. 5 shows one example of the related appliances database, which associates every home electric appliance 100 connected to the house server 300 with home electric appliances related thereto. For example, a clothes washer of the appliance ID: M001 is associated with a clothes dryer of the appliance ID: M002 and a clothes dryer of the appliance ID: M003 as related home electric appliances, respectively.

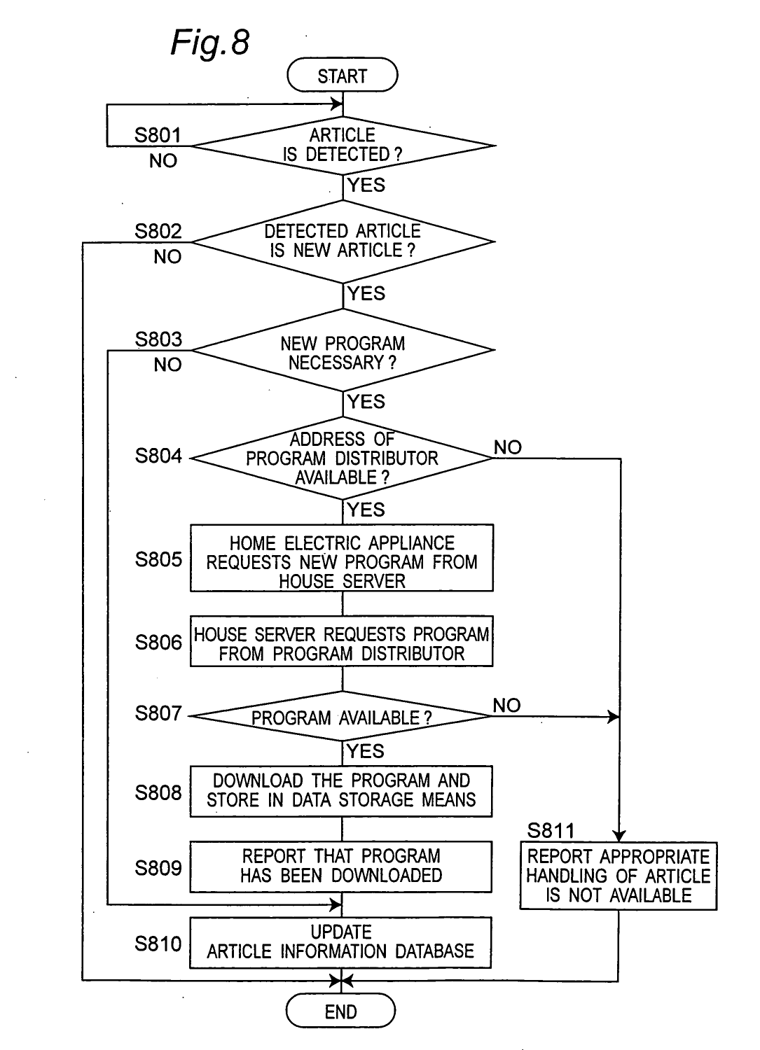

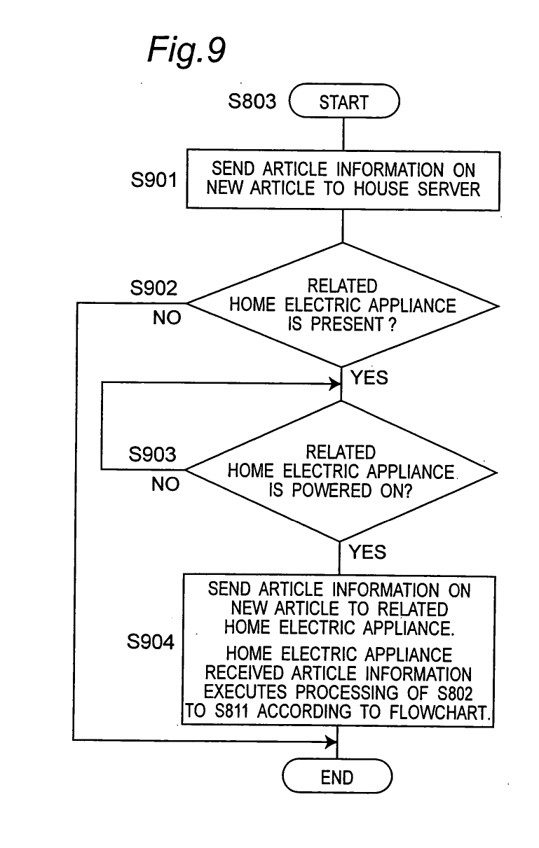

Description is now given of the processing of the home information appliance system with reference to the flowcharts shown in FIG. 8 and FIG. 9.

First, it is determined whether or not the article detection section 103 of any one of the home electric appliances 100 detects an article (step S801), and if an article is not detected at all, then the step S801 is repeated, whereas if an article is detected, the procedure proceeds to step S802. For example, when the user of the home electric appliances 100 puts an article in any one of the home electric appliances 100, the article detection section 103 of the home electric appliance 100 in which the article is put detects the article.

The information detection means 104 obtains information on an article detected by the article detection section 103 to identify the article. The comparison and confirmation means 110 make a reference to the article information database of the data storage means 105 to determine whether or not the identified article is a new article unregistered on the article information database (step S802). If the article is a new article, the procedure proceeds to step S803, whereas if the article is not a new article, the processing of the home information appliance system is ended.

The control means 107 of the home electric appliance 100 checks the article information database to determine whether or not a control program corresponding to the handling method for the new article is stored in the data storage means 105 based on the information on the new article, and determines the necessity of a new program based on the check result (step S803). If the control program corresponding to the new article is not stored in the data storage means 105 and the control means 107 determines that the new control program is necessary, then the procedure proceeds to step S804. If the control program corresponding to the new article is stored in the data storage means 105, then the control means 107 determines that the new control program is not necessary and so the procedure proceeds to step S810. It is to be noted that if the control program corresponding to the new article is not stored in the data storage means 105 and if, for example, the article is new though its handling method (control program) is identical to that of the article already registered on the article information database, then the control means 107 determines that the new control program is not necessary.

When a new control program is necessary, the control means 107 make a reference to the article information database to determine whether or not information indicating the program distribution apparatus 201 or 202 is present regarding the new particle (step S804). If such information is present, the procedure proceeds to step S605, whereas if such information is not present, then the procedure proceeds to step S811.

In the case where the information indicating the program distribution apparatus 201 or 202 is present, a request to download the new control program is made from the communication means 108 of the home electric appliance 100 to the control means 304 via the communication means 303 of the house server 300 (Step S805).

Upon reception of the download request, the control means 304 of the house server 300 orders the program download means 301 to execute download of a new control program. More specifically, under the control of the control means 304, the program download means 301 requests the program distribution apparatus 201 or 202, which involves the information on the new article and is capable of distributing the download-requested control program, to download the program through the network 200 (step S806). In this case, the control program downloaded from the program distribution apparatus 201 or 202 can be specified by the home electric appliance ID which made the request, the article ID, and the name of handling method control program (see FIG. 3A and FIG. 18).

Upon reception of the download request, the program distribution apparatus 201 or 202 determines whether or not the control program pertinent to the download request is present, and if the control program pertinent to the download request is present, a message notifying that the program is downloadable is sent to the program download means 301 through the network 200, whereas if the control program pertinent to the download request is not present or if the control program pertinent to the download request is present but the program is not downloadable, a message notifying that the program is not downloadable is sent to the program download means 301 through the network 200. Based on the information sent from the program distribution apparatus 201 or 202, the program download means 301 determines whether or not the control program which can support the new article is available (step S807), and if the control program which can support the new article is available, the procedure proceeds to step S808, whereas if the control program which can support the new article is not available, then the procedure proceeds to step S811.

When the program download means 301 downloads the new control program through the network 200, the program is temporarily stored in the data storage means 302. Then, the control program downloaded and stored in the data storage means 302 is sent to the communication means 108 of the home electric appliance 100 which made the download request through the communication means 303 of the house server 300. The home electric appliance 100 saves the new control program in the data storage means 105 (step S808). When the new control program is stored in the data storage means 105, the notification section 106 of the home electric appliance 100 notifies that the new control program has been downloaded, and the procedure proceeds to step S810 (Step S809).

In this case, the program to be downloaded is not limited to one kind (see FIG. 3A and FIG. 18). Some articles have a plurality of handling methods. For example, in the case where the home electric appliance ID is M001 (clothes washer) and the article ID is ID_001, there are three handling methods (control programs), and these three control programs, WAS_P001, WAS_P005, and WAS_P037, are downloadable.

The control means 107 registers the information on the new article (information including the ID of the new article, the home electric appliance ID thereof, and the handling method (control program) thereof) obtained by the information detection means 104 on the article information database of the home electric appliance 100 (step S810). In this case, the control means 107 also reports to the house server 300 that the new article has been registered through the communication means 108. The processing of the house server 300 upon reception of the report will be described later.

When the new control program is not available in the step S804 or S807, then the house server 300 reports it to the home electric appliance 100 which made the download request through the communication means 303, and the notification section 106 of the home electric appliance 100 notifies the user that appropriate handling of the new article is not available (step S811). In this case, the user manually selects the operation mode of the home electric appliance 100 from the input reception means 109, cancels handling of the article, or inputs the address of different program distribution apparatus 201 or 202 to re-execute the download by the house server 300.

Description is now given of the processing of the house server 300 in response to detection of the new article in the step S803, in accordance with the flowchart shown in FIG. 9.

First, in step S901, the home electric appliance 100 which detected a new article reports to the house server 300 that a new article has been detected. At this point of time, the home electric appliance 100 sends at least information to identify the home electric appliance 100 and information on the new article to the house server 300.

The control means 304 of the house server 300 makes a reference to the related appliances database (FIG. 5) in the data storage means 302 to determine whether or not other home electric appliances 100 related to the home electric appliance 100 which has sent the information on the new article, i.e., other home electric appliances 100 having possibility to handle the new article, are present (step S902). If other related home electric appliances 100 are not present, then the processing of the house server 300 is ended, whereas if other related home electric appliance(s) 100 are present, the procedure proceeds to step S903.

Once it is confirmed by the communication means 303 of the house server 300 that these other related home electric appliance(s) 100 are powered on, the procedure proceeds to step S904 (step S903).

The control means 304 of the house server 300 sends the information on the new article to the related home electric appliances 100. Upon reception of the information on the new article, the above other related home electric appliances 100 execute each processing of S802 to S811 according to the flowchart in FIG. 8. More particularly, in the above other related home electric appliances 100, if the article is a new article, then its information is registered on the article information database of the data storage means 105 in each of the above other related home electric appliances 100, and if a control program for the article is necessary, the house server 300 receives the download request. Then, a new control program downloaded by the house server 300 is stored in the data storage means 105 in each of the above other related home electric appliances 100 (step S904).

Description is now given of the processing of the home information appliance system in the second embodiment with specific examples. Herein, the processing of the home information appliance system will be described by taking the case where the article is a clothing article and the home electric appliances 100 are the clothes washer 100a, the (clothes) dryer 100b, and the clothes iron 100c as an example with reference to the databases of FIG. 3A and FIG. 5. It is to be noted that a tag is attached to each of clothes, and the home electric appliances 100a to 100c such as clothes washers are equipped with tag readers as the article detection section 103. Moreover, the tag contains information including the article ID, the handling method, the program distributor, the article form, and notice as information about the clothing article.

First, it is assumed that the user of the clothes washer 100a puts a clothing article in the clothes washer 100a to wash the clothing article. The article detection section 103 of the clothes washer 100a reads the tag data on the clothing article (step S801), by which the article is detected. In this case, it is assumed that the article ID of the clothing article is ID007.

The comparison and confirmation means 110 of the clothes washer 100a makes a reference to the article information obtained by the information detection means 104 and the article information database before update shown in FIG. 3A to determine whether or not the article of the article ID: ID007 is already registered (step S802). In this case, since the articles registered on the article information database before update shown in FIG. 3A are those with the article ID of ID001 to ID003, it is determined that the article of ID007 is a new article.

The control means 107 of the clothes washer 100a confirms the handling method for the new article (herein meaning the washing method) and checks if the article can be handled by the control programs currently possessed by the clothes washer 100a or if a new control program is necessary (step S803). More particularly, the tag data includes the program name of the handling method for the new article and the address of the program distribution apparatus 201 or 202 which can distribute the program (see FIG. 16), and the control means 107 of the clothes washer 100a determines whether or not the program name included in the tag has already been downloaded for washing of other articles (clothing articles). If the program has already been downloaded, it is determined that download of the new program is not necessary.

Here in the example of FIG. 16, the tag data indicates that the program name of the handling method for the new article (ID007) is WAS_P004 or WAS_P025, and since these methods are not yet registered on the article information database, the control means 107 determines that a new control program is necessary.

Consequently, the control means 107 makes a reference to the article information database to check whether or not the address of the program distribution apparatus 201 or 202 is present (step S804). More particularly, the tag data includes the address of the program distribution apparatus 201 or 202 which can distribute the handling method program with the name WAS_P004 or WAS_P025 for the new article (ID007) (see FIG. 16), and so the control means 107 of the clothes washer 100a makes a reference to the article information database, as a result of which it is determined that the program with the program name WAS_P004 or WAS_P025 should be downloaded from the program distribution apparatus 201 or 202. The clothes washer 100a sends the information on the handling methods WAS_P004 and WAS_P025, the address of the program distribution apparatus 201 or 202, the ID No. of the clothes washer 100a, and the names of the handling method control programs “WAS_P004” and “WAS_P025” together with the download request to the house server 300 from the communication means 108 (step S805).

It is to be noted that when the information on the program distribution apparatus 201 or 202 is not present (e.g., the tag attached to the clothing article does not have the information), a new control program cannot be obtained and so the user is notified by the notification section 106 that appropriate handling of the clothing article is not available (step S811).

Upon reception of the download request, the house server 300 accesses to the program distribution apparatus 201 or 202 based on the information received together with the request, and requests the control programs WAS_P004 and WAS_P025 (step S806). When the control program WAS_P004 or WAS_P025, or both the control programs are available (step S807), the house server 300 downloads the control programs and uploads the downloaded control programs to the clothes washer 100a (step S808). Then, the notification section 106 notifies that the new control programs have been downloaded (step S809), and further the control means 107 additionally registers the information on the new article (information stored in the tag including the article ID, the handling method (control program), and the program distribution apparatus) obtained by the information detection means 104 on the article information database of the data storage means 105 (step S810). By this, the article information database is put in the state as shown in FIG. 3B.

It is to be noted that when the control programs WAS_P004 and WAS_P025 are not available, the notification section 106 notifies that appropriate washing is not available due to the lack of the necessary program for washing of the clothing article (step S811).

Moreover, at the point of time when the article is determined to be a new clothing article, the information on the new clothing article is sent from the clothes washer 100a to the house server 300 (step S901 in FIG. 9), and the house server 300 makes a reference to the related appliances database (FIG. 5) to check other home electric appliances 100 related to the clothes washer 100a (step S902). The clothes dryer 100b and the clothes iron 100c are associated with the clothes washer 100a as other home electric appliances 100 related to the clothes washer 100a, and so once the clothes dryer 100b and the clothes iron 100c are powered on (step S903), the house server 300 sends the information on the new clothing article thereto (step S904). Then, the clothes dryer 100b and the clothes iron 100c respectively execute each processing of the steps S802 to S811 according to the flowchart in FIG. 8.

Thus, in the home information appliance system in the second embodiment, when a new article is put in any one of a plurality of the home electric appliances 100 (when handling of a new article is requested), it is speculated that other home electric appliances 100 eventually need a new control program corresponding to the new article, and therefore the house server 300 identifies the related home electric appliances 100 and executes download of the new control programs for these related home electric appliances 100 where necessary. As a consequence, each of a plurality of the home electric appliances 100 can obtain the control program corresponding to the new article in advance before handling the new article. More particularly, all the home electric appliances 100 are put in the state capable of handling the handling-target article without requiring involvement of the user. Moreover, with the control program obtained in advance, when the related home electric appliances 100 are operated to handle the new article, the handling of the article can be started immediately without the necessity of downloading the new control program.

Further, when a new article is found out, the house server 300 determines related home electric appliances 100 and downloads a new control program, and therefore the user of the home information appliance system does not have to connect the home electric appliances 100 in consideration of the association among the home electric appliances 100 but has only to connect the home electric appliances 100 to the house server 300.

### MODIFIED EXAMPLE

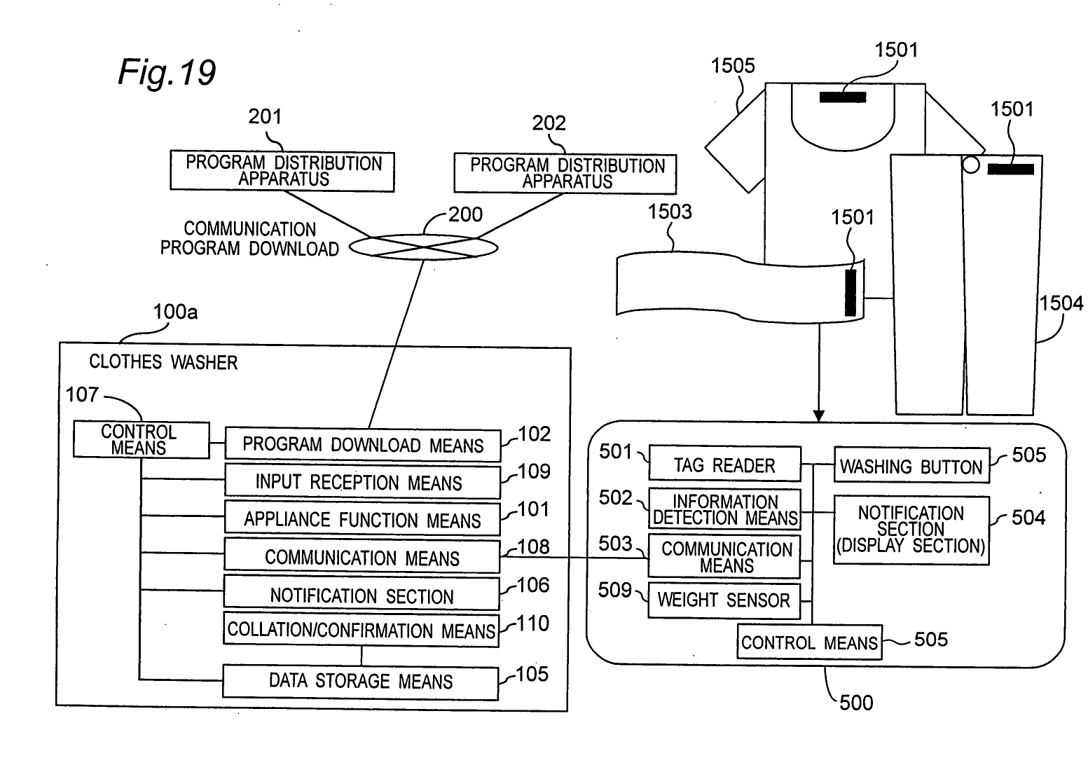

Although in the first embodiment or the second embodiment, the article detection section 103 for detecting and identifying articles is mounted on each of the home electric appliances 100, the apparatus for detecting and identifying articles may be created specifically so as to correspond to a specific home electric appliance 100 on one-on-one level. More specifically, as shown in FIG. 19, when a laundry basket 500 for containing unwashed clothing articles is present with respect to the clothes washer 100a, the laundry basket 500 may have a function to detect and identify articles.

FIG. 19 is a view showing the constitution of a home information appliance system in the case where the laundry basket 500 has a function to detect and identify articles. It is to be noted that in the home information appliance system, a tag 1501 is attached to each clothing article.

The laundry basket 500 includes, a tag reader 501 as the article detection section, an information detection means 502, a communication means 503 for establishing communication with the communication means 108 of the clothes washer 100a by fixed-lines and/or radio (by radio in the example in the figure), a notification section (display section) 504, a washing button 505, and a control means 506 for controlling the respective means 501 to 505.

The tag reader 501 reads the tag data attached to a clothing article put in the laundry basket 500 to detect the clothing article.

The information detection means 502 obtains the information on the clothing article based on the information read by the tag reader 501 to identify the clothing article. At this point, the information ready by the tag reader 501 is collated with the information regarding the relationship between information in the tag containing the manufacturer, the material, or the like of the clothing article and the clothing article, the information being pre-registered on a database which is possessed inside the information detection means 502, so as to identify the article.

The notification section 504 provides (displays) information to the user of the clothes washer 100a as described later.

The washing button 505 is a button operated by the user when clothing articles contained in the laundry basket 500 are washed by the clothes washer 100a, and as described later, operating the washing button 505 sends information on the clothing articles contained in the laundry basket 500 to the communication means 108 of the clothes washer 100a through the communication means 503.

The clothes washer 100a in the home information appliance system includes an appliance function means 101, a program download means 102, a data storage means 105, a notification section 106, a communication means 108, a comparison and confirmation means 110, an input reception means 109, and a control means 107, but does not include an article detection section 103 and a information detection means 104 unlike the home electric appliance 100 in the first embodiment and the second embodiment. This is because the laundry basket 500 corresponding to the clothes washer 100a on one-on-one level includes the tag reader 501 functioning as the article detection section and the information detection means 502. It is to be noted that each of the appliance function means 101, the data storage means 105, the notification section 106, the communication means 108, and the control means 107 in the clothes washer 100a are identical in function to each means in the home electric appliance 100 in the first embodiment and the second embodiment, and so the description thereof is omitted herein.

Description is now given of the processing of the home information appliance system. First, when a certain clothing article is put in the laundry basket 500, the tag reader 501 reads the tag data attached to the clothing article, and the information detection means 502 obtains the information on the clothing article to identify the clothing article.

Once the information detection means 502 identifies the clothing article, the information is sent to the communication means 108 of the clothes washer 100a through the communication means 503. Upon reception of the clothing article identification information, the clothes washer 100a executes each processing from the step S602 to S610 in the flowchart shown in FIG. 6, and obtains a new control program from the program distribution apparatus 201 or 202 by the program download means 102 where necessary.

Moreover, when a clothing article is identified by the information detection means 502, information on the clothing article is displayed on the display section 504 in the laundry basket 500 (see FIG. 16). More particularly, the clothing article name (ID), the number of clothing articles, the handling method for the clothing article, and the like are displayed on the display section 504. For example, displayed in FIG. 16 are ID007 as the clothing article name (ID), WAS_P004 etc. as the handling method for the clothing article, the address of a program distributor, and the like.

Thus, clothing articles are put in the laundry basket 500 in sequence, and by mounting a weight sensor 509 on the laundry basket 500 for example, a warning message can be indicated by the display section 504 if the total weight of the clothing articles in the basket 500 detected by the weight sensor 509 exceeds a limit weight of the clothes washer 100a.

In this case, not only the warning message is indicated, but also for those clothing articles put in late, “not washable” is displayed on the “state” column on the display section 504 by the control means 505, whereas for those clothing articles falling within the range of the limit weight of the clothes washer 100a, “washable” is displayed on the “state” column on the display section 504, so that the user may be notified of the condition.

Moreover, aside from this, a combination which allows a maximum amount of clothing articles to be washed within the range of the limit weight of the clothes washer 100a may be selected by the control means 505, and as a result of the selection, for those clothing articles to wash, “washable” is displayed on the “state” column on the display section 504 by the control means 505, whereas for those clothing articles not to be washed, “not washable” is displayed on the “state” column on the display section 504 by the washing means 505 so that the user may be notified of the condition.

The handling method for each clothing article in the clothes washer 100a is constituted of setting the ranges of the solution amount, the washing time, the number of rinsing times, and the like as described above, and the clothes washer 100a is an apparatus for handling (washing) a plurality of clothing articles at a time, so that for washing the clothing articles in the laundry basket 500, a handling method which satisfies the ranges of the solution amount, the washing time, the number of rinsing times, and the like set for all the clothing articles (clothing articles set to be washable) put in the laundry basket 500 is set to be selected. Consequently, when a plurality of clothing articles not overlapping in the range of the solution amount or the like, i.e., the clothing articles having no operation programs common to each other, are put in the laundry basket 500, the control means 505 may display the condition on the display section 504 to notify the user. Also in this case like the case where the clothing articles to be washed are selected in terms of the limit weight, the handling method allowing a maximum amount of clothing articles to be washed is set by the control means 505 and for those clothing articles which can be handled by the handling method, “washable” is displayed on the “state” column on the display section 504 by the control means 505, whereas for those clothing articles which cannot be handled, “not washable” is displayed on the “state” column on the display section 504 by the washing means 505 so that the user may be notified of the condition.

Then, when the user do the washing, the user see the display on the display section 504 of the laundry basket 500, and removes the clothing articles which are displayed “not washable” from the laundry basket 500 for example. At this point, in the case where, for example, the tag contains a recommended detergent, colored article information, or the like, the recommended detergent information, the colored article information, or the like can be displayed on the display section 504 as remarks information, which enables the user to select a detergent based on the information.

When the user operates the washing button 505 on the laundry basket 500, the information on each clothing article put in the clothes washer 100a and the information on the selected handling method are sent to the clothes washer 100a via the communication means 503.

Then, when the user puts the clothing articles, which are in the laundry basket 500, in the clothes washer 100a, the clothes washer 100a executes washing of the clothing articles by the appliance function means 101 under the control of the control means 107 based on the received information.

In the home information appliance system in the modified example, the control programs necessary for the clothing articles put in the laundry basket 500, i.e., the respective clothing articles required to be washed by the clothes washer 100a, are obtained in advance before execution of the washing operation, which makes it possible to put the clothes washer 100a in the state capable of washing the clothing articles put in the laundry basket 500 without requiring involvement of the user.

Moreover, since an optimum handling method is automatically set by the control means 505 in consideration of the combination of the clothing articles put in the laundry basket 500, the clothing articles can be washed in the optimum state without setting of the handling method by the user herself/himself. Further, in conformity with the limit weight of the clothes washer 100a and the handling method for every clothing article, the selection of clothing articles is also automatically executed by the control means 505, which enables the user to do washing without effort and time.

It is to be noted that the house server 300 of the second embodiment in FIG. 2 may be added to the home information appliance system in the modified example. Moreover, the clothes washer 100a may have the article detection section 103 and the information detection means 104 of the first embodiment or the second embodiment.

Moreover, the laundry basket 500 is still effective if the clothes washer 100a does not download new control programs and only executes washing according to the control program in conformity with the attributes of clothing articles.

### THIRD EMBODIMENT

Although in the respective embodiments, the home electric appliances handing articles have been described, the home information appliance system of the present invention is also applicable to information appliances handing information.

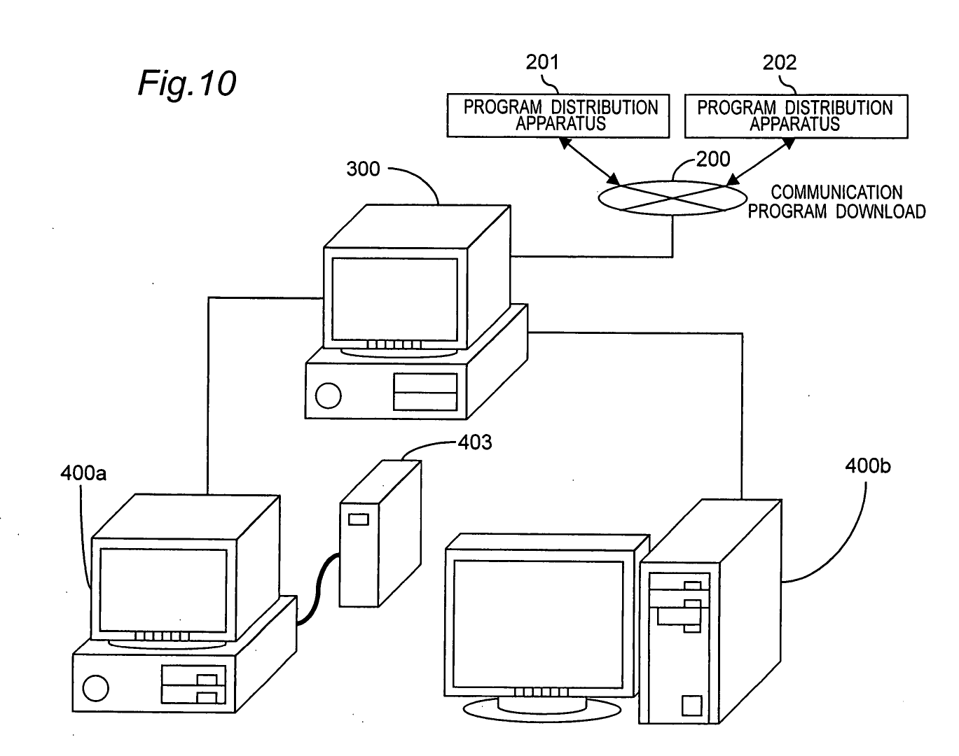

FIG. 10 is a view showing the home information appliance system applied to information appliance systems.

The home information appliance system has a house server 300 so that when one of a plurality of information appliances 400 (including a Linux (trademark) personal computer 400a and a FreeBSD (trademark) personal computer 400b and the like) downloads new programs (referring to new control programs and other programs though in the following description, these programs are simply referred to as “control programs” for simplification), new control programs for other related information appliances 400 are also downloaded where necessary. Herein, the house server 300 is a server exercising control over the respective information appliances 400, and the information appliances 400 and the house server 300 are connected to each other by fixed lines or by radio (Local Area Network or LAN).

As in the case of the clothes washer 100a shown in FIG. 2, the respective information appliances 400 include an appliance function means 101, a communication means 108 for communication on the LAN, an article detection section 103, an information detection means 104, a data storage means 105, a notification section 106, an input reception means 109, a comparison and confirmation means 110, and a control means 107 for controlling these respective means.

As in the case of the house server 300 shown in FIG. 2, the house server 300 includes a program download means 301, a data storage means 302, a communication means 303, and a control means 304 for controlling these respective means 301 to 303.

The appliance function means 101, the article detection section 103, the information detection means 104, the data storage means 105, the notification section 106, the input reception means 109, and the comparison and confirmation means 110 in each of the information appliances 400 share almost the same functions with the appliance function means 101, the article detection section 103, the information detection means 104, the data storage means 105, the notification section 106, the input reception means 109, and the comparison and confirmation means 110 in the first embodiment and the second embodiment. More particularly, the appliance function means 101 in each of the information appliances 400 fulfills functions peculiar to the information appliance 400. The article detection section 103 in each of the information appliances 400 detects articles with use of a camera, a tag reader, and the like attached to each of the information appliances 400, and also detects articles connected to information appliances through plug and play. The information detection means 104 in each of the information appliances 400 detects information on an article detected by the article detection section 103. The data storage means 105 in each of the information appliances 400 has various programs relating to the pertinent information appliance 400 and an article information database, and manage them. The notification section 106 in each of the information appliance 400 provides information to the user of the information appliance 400 by the means of voice, display, lamps, and the like. The input reception means 109 in each of the information appliances 400 is used when the user desires to set the operation method for the information appliance 400 manually. The comparison and confirmation means 110 in each of the information appliances 400 checks whether or not the information on the article obtained by the information detection means 104 is registered on an article information database (see FIG. 3A) stored in the data storage means 105, and sends the result to the control means 107 so as to confirm whether or not the article is a new article.

The program download means 301 in the house server 300 has almost the same functions as those of the program download means 103 in the first embodiment or the program download means 301 in the second embodiment. More particularly, in response to requests from the control means 304 of the house server 300, the program download means 301 of the house server 300 downloads control programs for various information appliances 400 from the program distribution apparatus 201 or 202 through the network 200 and stores them in the data storage means 302.

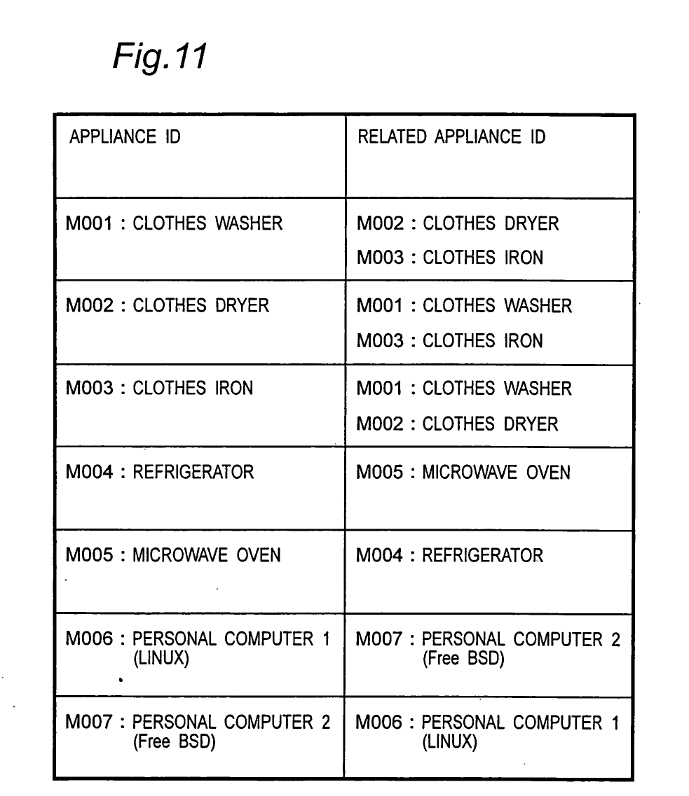

Moreover, the data storage means 302 has a related appliances database which stores information on mutually related information appliances 400 for a plurality of kinds of information appliance 400 subject to centralized control by the house server 300 (see the appliance ID: M006 on the lowermost section and the appliance ID: M007 immediately above the section in FIG. 11). The related information appliances 400 refer to appliances which handle the same kind of articles. For example, the personal computer 400a with Linux installed and the personal computer 400b with FreeBSD installed are related appliances in the point that both the appliances can handle external information appliances (including a hard disc 403 or a CD-ROM drive).

FIG. 11 shows one example of the related appliances database in the case where the information appliances 400 are additionally connected to the house server 300 in the home information appliance system of the second embodiment in FIG. 2, and in the database, every home electric appliance 100 and information appliance 400 connected to the house server 300 are associated with the home electric appliances 100 and the information appliances 400 related thereto.

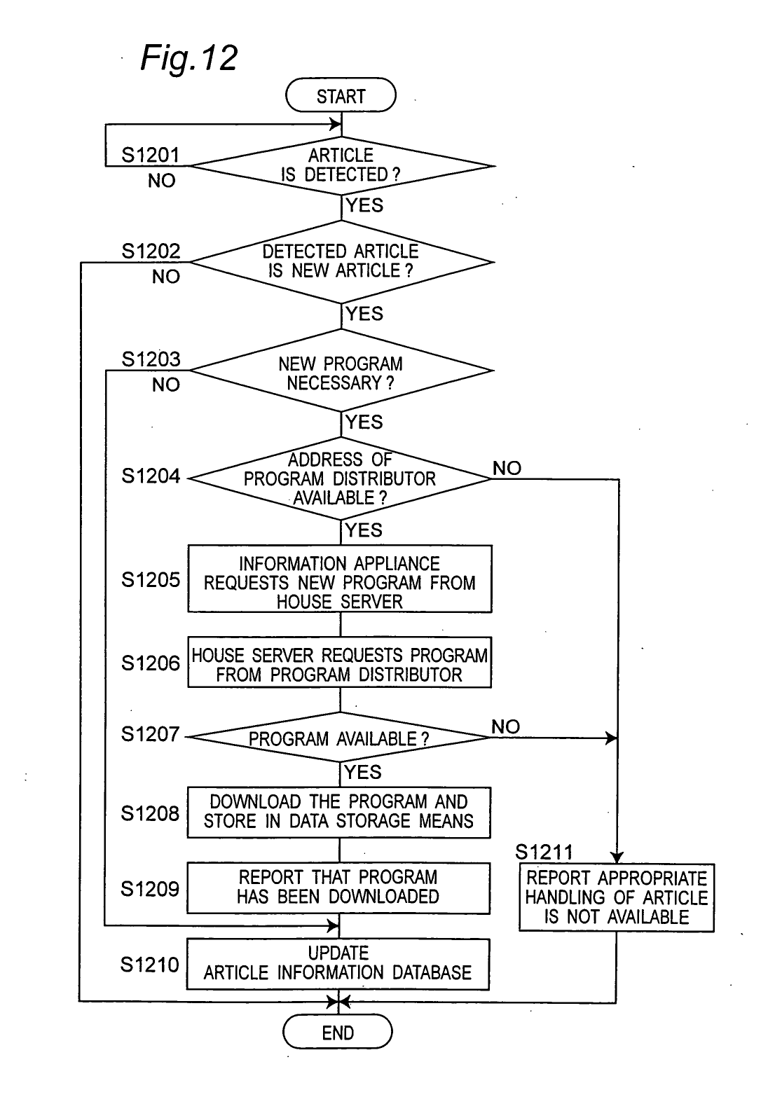

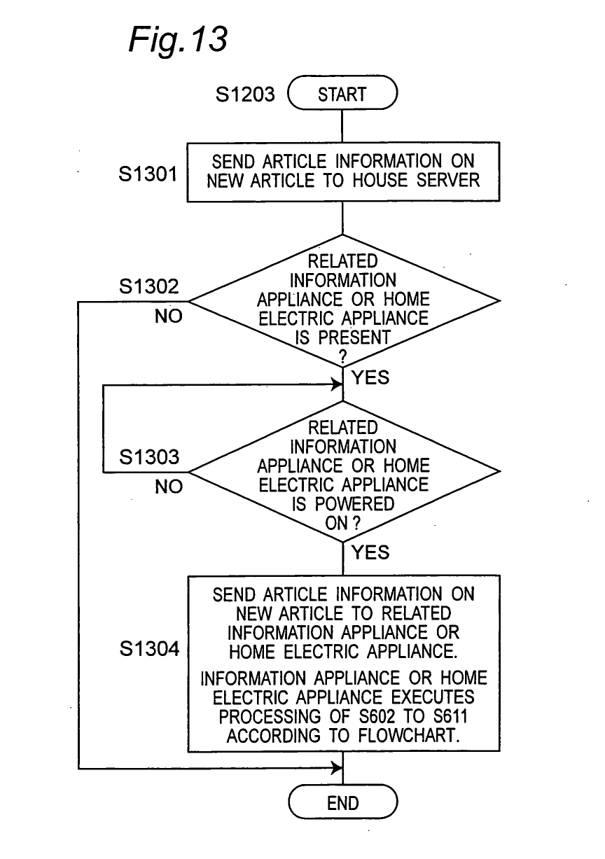

Description is now given of the processing of the home information appliance system with reference to the flowcharts shown in FIG. 12 and FIG. 13.

First, it is determined whether or not the article detection section 103 of any one of the information appliances 400 detects an article (step S1201), and if an article is not detected at all, then the step S1201 is repeated, whereas if an article is detected, the procedure proceeds to step S1202. For example, when the user of the information appliances 400 connects an article to any one of the information appliances 400, the article detection section 103 of the information appliance 400 to which the article is connected detects the article.

The information detection means 104 obtains information on an article detected by the article detection section 103 to identify the article as with the case of the previous embodiment. Then, the comparison and confirmation means 110 make a reference to the information obtained by the information detection means 104 and to the article information database of the data storage means 105 to determine whether or not the identified article is a new article unregistered on the article information database (step S1202). If the article is a new article, the procedure proceeds to step S1203, whereas if the article is not a new article, the processing of the home information appliance system is ended.

The control means 107 of the information appliance 400 checks the article information database to determine whether or not a control program corresponding to the handling method for the new article is stored in the data storage means 105 based on the information on the new article, and determines the necessity of a new program based on the result, as with the case of the previous embodiment (step S1203). If the control program corresponding to the new article is not stored in the data storage means 105 and the control means 107 determines that the new control program is necessary, then the procedure proceeds to step S1204. If the control program corresponding to the new article is stored in the data storage means 105, then the control means 107 determines that the new control program is not necessary and so the procedure proceeds to step S1210. It is to be noted that if the control program corresponding to the new article is not stored in the data storage means 105 and if, for example, the article is new though its handling method (control program) is identical to that of the article already registered on the article information database, then the control means 107 determines that the new control program is not necessary.

When a new control program is necessary, the control means 107 make a reference to the article information database to determine whether or not information indicating the program distribution apparatus 201 or 202 is present regarding the new particle (step S1204). In the case where the information is present, the procedure proceeds to step S1205, whereas if the information is not present, then the procedure proceeds to step S1211.

When the program distribution apparatus 201 or 202 is indicated, a request to download the new control program is made from the communication means 108 of the information appliance 400 to the control means 304 via the communication means 303 of the house server 300 (step S1205).

Upon reception of the download request, the control means 304 of the house server 300 orders the program download means 301 to execute download of a new control program. More specifically, under the control of the control means 304, the program download means 301 requests the program distribution apparatus 201 or 202, which involves the information on the new article and is capable of distributing the download-requested control program, to download the program through the network 200 (step S1206). In this case, the control program downloaded from the program distribution apparatus 201 or 202 can be specified by the information appliance ID which makes the request, the article ID, and the program name of handling (operation) method as similar to the case of the first embodiment and the second embodiment.

Upon reception of the download request, the program distribution apparatus 201 or 202 determines whether or not the program pertinent to the download request is present, and if the control program pertinent to the download request is present, a message notifying that the program is downloadable is sent to the program download means 301 through the network 200, whereas if the control program pertinent to the download request is not present or if the control program pertinent to the download request is present but the control program is not downloadable, a message notifying that the program is not downloadable is sent to the program download means 301 through the network 200. Based on the information sent from the program distribution apparatus 201 or 202, the program download means 301 determines whether or not the control program which can support the new article is available (step S1207), and if the control program which can support the new article is available, the procedure proceeds to step S1208, whereas if the control program which can support the new article is not available, then the procedure proceeds to step S1211.

When the program download means 301 downloads the new control program through the network 200, the program is temporarily stored in the data storage means 302. Then, the downloaded program is sent to the communication means 108 of the information appliance 400 which makes the download request through the communication means 303 of the house server 300. The home information appliance 400 which makes the download request saves the new control program in the data storage means 105 (step S1208). When the new control program is stored in the data storage means 105, the notification section 106 of the information appliance 400 notifies that the new control program has been downloaded, and the procedure proceeds to step S1210 (Step S1209).

The control means 107 registers the information on the new article (information including the ID of the new article, the information appliance ID, and the handling method (control program), etc.) obtained by the information detection means 104 on the article information database of the information appliance 400 (step S1210). In this case, the control means 107 also reports to the house server 300 that the new article has been registered through the communication means 108. The processing of the house server 300 upon reception of the report will be described later.

When the new control program is not available in the step S1204 or S1207, the house server 300 reports it to the information appliance 400 which makes the download request through the communication means 303, and the notification section 106 of the information appliance 400 notifies the user that appropriate handling of the new article is not available (step S1211). In this case, the user manually selects the operation mode of the information appliance 400 from the input reception means 109, cancels handling of the article, or inputs the address of different program distribution apparatus 201 or 202 to re-execute the download.

Description is now given of the processing of the house server 300 in response to detection of the new article in the step S1203, according to the flowchart shown in FIG. 13.

First, in step S1301, the information appliance 400 which detects a new article reports to the house server 300 that a new article has been detected. At this point of time, the information appliance 400 sends at least information to identify the information appliance 400 and information on the new article to the house server 300.

The control means 304 of the house server 300 makes a reference to the related appliances database (FIG. 11) in the data storage means 302 to determine whether or not other information appliances 400 or home electric appliances 100 related to the information appliance 400 which has sent the information on the new article, i.e., other information appliances 400 or home electric appliances 100 having possibility to handle the new article, are present (step S1302). If other related information appliances 400 or home electric appliances 100 are not present, then the processing of the house server 300 is ended, whereas if other information appliance 400 or home electric appliances 100 are present, the procedure proceeds to step S1303.

Once it is confirmed by the communication means 303 of the house server 300 that these other related information appliances 400 or home electric appliances 100 are powered on, the procedure proceeds to step S1304 (step S1303).

The control means 304 of the house server 300 sends the information on the new article to the above other related information appliances 400 or home electric appliances 100. Upon reception of the information on the new article, the above other related information appliances 400 or home electric appliances 100 execute each processing of S1202 to S1211 according to the flowchart in FIG. 12. More particularly, in the above other related information appliances 400 or home electric appliances 100, if the article is a new article, then its information is registered on the article information database of the data storage means 105 in each of the above other related information appliances 400 or home electric appliances 100, and if a control program for the article is necessary, the house server 300 receives the download request. Then, a new control program downloaded by the house server 300 is stored in the data storage means 105 in each of the above other related information appliance 400 or home electric appliances 100 (step S1304).

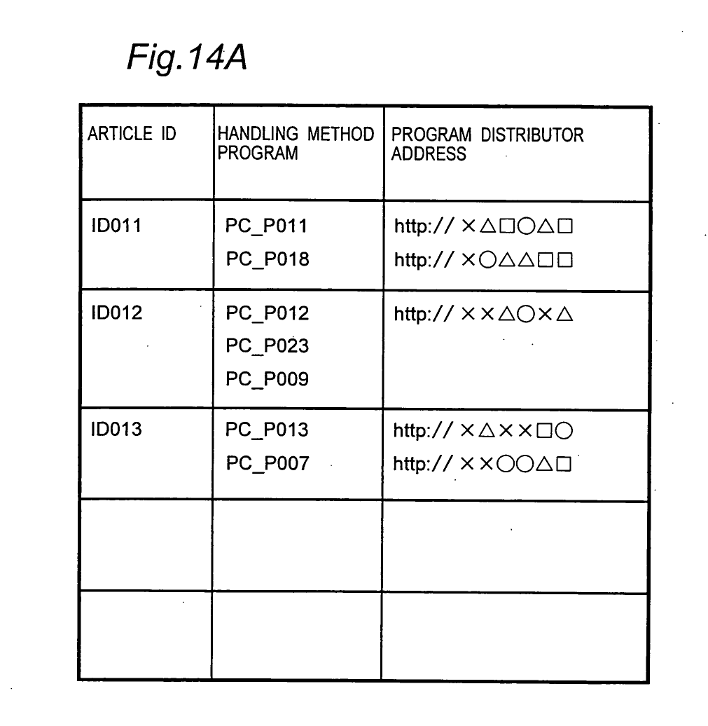

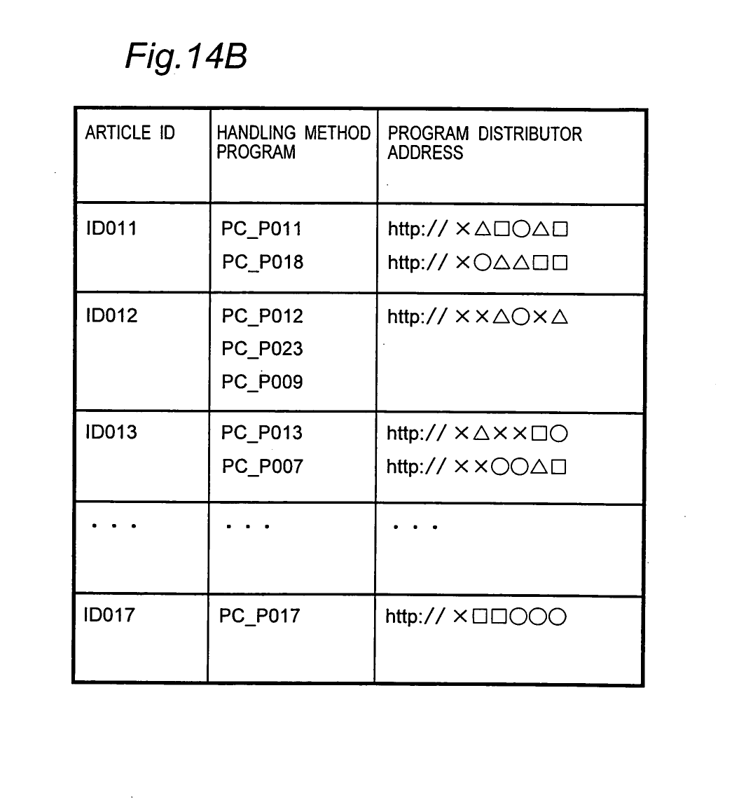

Description is now given of the processing of the home information appliance system in the third embodiment with specific examples. Herein, the processing of the home information appliance system will be described by taking the case where the article is a hard disk, the information appliance 400a is a personal computer with Linux installed, and the information appliance 400b is a personal computer with FreeBSD installed as an example with reference to the databases in FIG. 11 and FIG. 14A. It is to be noted that as the article detection section 103, a personal computer 400 can detect that a hard disk 403 is connected to the personal computer 400 through plug and play and can obtain information on the hard disk 403.

First, it is assumed that the user of the personal computer 400a connects the hard disk 403 to the personal computer 400a to use the hard disk 403. The article detection section 103 of the personal computer 400a can read the information on the hard disk 403 (step S1201), by which the article is detected. In this case, it is assumed that the article ID of the hard disk 403 is ID017.

The information detection means 104 of the personal computer 400a obtains information on the article, and the comparison and confirmation means 110 makes a reference to the article information obtained by the information detection means 104 and to the article information database before update shown in FIG. 14A to determine whether or not the article of the article ID: ID017 is already registered (step S1202). In this case, since the articles registered on the article information database before update shown in FIG. 14A are those with the article IDs of ID011 to ID013, it is determined that the article of ID017 is a new article.

Consequently, the control means 107 of the personal computer 400a confirms the handling method for the new article, and checks if the article can be handled by the control programs currently possessed by the personal computer 400a or if a new control program is necessary (step S1203). More particularly, the information obtained by the information detection means 104 includes the program name necessary for handling the hard disk 403, based on which the control means 107 confirms whether or not the program is already in the data storage means of the personal computer 400a. If the program is not in the data storage means, then a new program is necessary.

In this case, the name of the handling method program for the new article (ID017) included in the information obtained by the information detection means 104 is PC_P017, and since the method is not yet registered on the article information database, the control means 107 determines that a new control program is necessary.

Consequently, the control means 107 makes a reference to the article information database to check the program distribution apparatus 201 or 202 (step S1204), and the personal computer 400a sends the information on the handling method PC_P017, the address of the program distribution apparatus 201 or 202, the ID No. of the personal computer 400a, and the name of the handling method control program PC_P017 together with the download request to the house server 300 from the communication means 108 (step S1205).

It is to be noted that when the information on the program distribution apparatus 201 or 202 is not present, a new control program cannot be obtained and so the user is notified by the notification section 106 that appropriate handling of the clothing article is not available (step S1211).

Upon reception of the download request, the house server 300 accesses to the program distribution apparatus 201 or 202 based on the information received together with the request, and requests the control program PC_P017 (step S1206). When the control program PC_P017 is available (step S1207), the house server 300 downloads the control program and uploads the downloaded control program to the personal computer 400a (step S1208). Then, the notification section 106 notifies that the new control program has been downloaded (step S1209), and the control means 107 additionally registers the information on the new article (information including the article ID, the handling method (control program), and the program distribution apparatus) obtained by the information detection means 104, on the article information database of the data storage means 105 (step S1210). By this, the article information database is put in the state as shown in FIG. 14B.

It is to be noted that when the control program of ID017 is not available, the notification section 106 notifies that appropriate control is not available due to the lack of the necessary program for control of the hard disk 403 (step S1211).

Moreover, at the point of time when the article is determined to be a new article, the information on the new article is sent from the personal computer 400a to the house server 300 (step S1301 in FIG. 13), and the house server 300 makes a reference to the related appliances database (FIG. 11) to check other information appliances 400 or home electric appliances 100 related to the personal computer 400a (step S1302) In this case, the personal computer 400b is associated with the personal computer 400a as other information appliance 400 related to the personal computer 400a, and so once the personal computer 400b is powered on (step S1303), the house server 300 sends the article information on the new hard disk 403 thereto (step S1304). Then, the personal computer 400b executes each processing of the steps S1202 to S1211 according to the flowchart in FIG. 12.

Thus, in the home information appliance system in the third embodiment, when a new article is put in any one of a plurality of the information appliances 400 and a plurality of home electric appliances 100 which exist in a mixed state (when handling of a new article is requested), it is speculated that other information appliances 400 or home electric appliances 100 eventually need a new control program corresponding to the new article, and therefore the house server 300 identifies the above other related information appliances 400 or home electric appliances 100 and executes download of the new control programs for these other related information appliance 400 or home electric appliances 100 where necessary. By this, the plurality of the information appliances 400 and home electric appliances 100 can respectively obtain the control program corresponding to the new article in advance before handling the new article. More particularly, all the information appliances 400 and home electric appliances 100 are put in the state capable of handling the handling-target article without requiring involvement of the user. Moreover, with the control program obtained in advance, when the above other related information appliances 400 and home electric appliances 100 are operated to handle the new article, the handling of the article can be started immediately without the necessity of downloading the new control program.

### OTHER EMBODIMENTS

As described above, the home electric appliance 100 can detect an article and execute operation suitable for the article, though the number of the handling methods for the article is not necessarily one but sometimes a plurality of methods are present. In the case of the clothes washer 100a for example, when a plurality of clothing articles are put in a drum at the same time and if a control program which can handle all the clothing articles is present, the control program is selected to do washing, whereas if the control program which can handle all the clothing articles is not present, the user is notified by the notification section 106 as described before.

Assumed for example that the clothing article of ID001 has three kinds of washing methods (control programs that are the handling methods) (see FIG. 3A and FIG. 3B), the results of the respective washing operations (the moisture contents, the tangled levels (wrinkles) of the clothing articles after washing, etc.) are considered to be slightly different from each other.

Consequently, by sending the information on the handling method (control program) used in the clothes washer 100a by the communication means 108 to the control means 107 through the communication means 108 of the clothes dryer 100b, the clothes dryer 100b which handles the clothing article following the clothes washer 100a can select the drying method for the clothing article (handling method, i.e., control program) in consideration of the condition of the clothing article washed immediately before the drying operation.

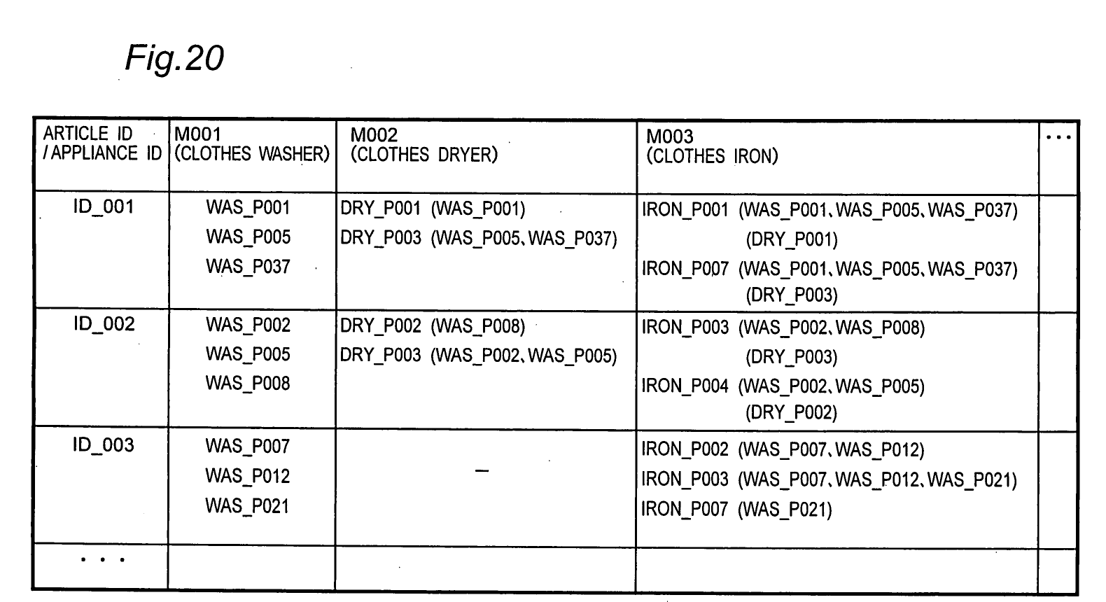

FIG. 20 shows an example of the article information database possessed by each home electric appliance 100 in the form of the table, which is a list of article operation programs recommended to execute when bracketed operations (handlings) are executed. In this table, the vertical column of the appliance ID: M001 represents an article information database possessed by the clothes washer 100a (same for the appliance ID: M002 and followings). It is to be noted that the list of the program distribution apparatus 201 or 202 is omitted. Moreover, association with the article handling method immediately before the pertinent method may be added to a new control program by the program distribution apparatus 201 or 202 when the new control program is downloaded, or may be written onto the tag attached to the article. For example, it is assumed that the clothing articles of ID_001 and ID_002 are put in the clothes washer 100a. In this case, the clothes washer 100a selects WAS_P005 which can handle both the clothing articles of ID_001 and ID_002 from the article information database as the washing method.

During washing operation or after washing operation, the clothes washer 100a sends information that the washing operation has been executed with use of the control program WAS_P005 from the communication means 108 of the clothes washer 100a to the clothes dryer 100b and the clothes iron 100c which are other home electric appliances related to the clothes washer 100a and registered on the related appliances database.

In the case where the clothing articles are put in the clothes dryer 100b after the washing operation, the clothes dryer 100b detects the clothing articles of ID_001 and ID_002, and based on the information that the control program WAS_P005 has been used sent from the clothes washer 100a, selects a control program DRY_P003 (recommended when the control program WAS_P005 is used) associated with the control program WAS_P005 as a drying method from the article information database

Similarly, upon reception of the information that the drying operation has been executed with use of the control program DRY_P003 from the clothes dryer 100b, the clothes iron 100c can execute ironing operation with use of a program IRON_P007 for the clothing article of ID_001 and a program IRON_P003 for the clothing article of ID_002, respectively.

It is understood that although description has been give on the collaboration between the clothes washer 100a, the clothes dryer 100b, and the clothes iron 100c, the present invention is applicable to the collaboration between other home electric appliances 100, such as the refrigerator 100d and the microwave oven. Thus, providing collaboration between the home electric appliances 100 allows more appropriate operation of the articles.

By properly combining the arbitrary embodiments of the aforementioned various embodiments, the effects possessed by the embodiments can be produced.

As described above, the present invention is effective for the home information appliance system or the like which can maintain home electric appliances and all the home electric appliances related to the home electric appliances in the state constantly capable of handling handling-target articles without requiring involvement of users of the home electric appliances and can reduce communication traffic, and which includes the home electric appliances such as clothes washers, clothes dryers, clothes irons, refrigerators, and microwave ovens, which handle articles.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A home information appliance system, comprising:
a plurality of home electric appliances having various control programs corresponding to respective attributes of a plurality of articles, handling the articles in conformity with the control programs, and connected to each other by fixed lines and/or radio;
a program distribution means capable of distributing the control programs to the respective home electric appliances; and
a network capable of connecting the respective home electric appliances and the program distribution means to each other,
the respective home electric appliances comprising:
a storage means having a related appliances database including information on mutual association among the plurality of the home electric appliances;
an article detection section for detecting an article to be handled by the pertinent home electric appliance among a plurality of the articles;
an information detection means for detecting information on the article detected by the article detection section to identify the article;
a program download means for downloading a control program corresponding to the identified article from the program distribution means through the network when the corresponding control program is not present; and
a control means for controlling respective operations of the storage means, the information detection means, and the program download means, and executing handling of the identified article in conformity with the control program corresponding to the identified article based on an identification result of the handling-target article, while making a reference to the information on mutual association among a plurality of the home electric appliances in the related appliances database to distribute information on the identified article to other home electric appliances related to the pertinent home electric appliance downloaded the program, wherein
upon reception of information on the article distributed from one of a plurality of the home electric appliances, the control means of other home electric appliances determine whether or not a control program corresponding to the pertinent article is present, and controls the program download means to download the corresponding control program from the program distribution means through the network if the control program is not present.

2. A home information appliance system, comprising:
a plurality of home electric appliances having various control programs corresponding to respective attributes of a plurality of articles and handling the articles in conformity with the control programs;
a server connected to the respective home electric appliances by fixed lines and/or radio;
a program distribution means capable of distributing the control programs to the respective home electric appliances; and
a network capable of connecting the server and the program distribution means to each other,
the respective home electric appliances comprising:
an article detection section for detecting an article to be handled by the pertinent home electric appliance among a plurality of the articles;
an information detection means for detecting information on an article detected by the article detection section to identify the article; and
a control means for executing handling of the article in conformity with the control program corresponding to the article based on an identification result of the article, and requesting the server to download the control program corresponding to the identified article if the corresponding control program is not present,
the server comprising:
a storage means having a related appliances database including information on mutual relation among a plurality of the home electric appliances;
a program download means for, in response to download requests from the respective home electric appliances, downloading the control program, which is for the home electric appliance requested the download and which corresponds to the identified article, from the program distribution means through the network; and
a control means for distributing the downloaded control program to the home electric appliance requested the download, and making a reference to the related appliances database to distribute information on the identified article to home electric appliances related to the home electric appliance requested the download, wherein
upon reception of information on the article distributed from one of a plurality of the home electric appliances, the control means of other home electric appliances determine whether or not a control program corresponding to the pertinent article is present, and request the server to download the corresponding control program if the control program is not present.

3. The home information appliance system as defined in claim 1, wherein
one of the home electric appliances is a clothes washer,
the clothes washer has:
an article detection section for detecting clothing articles contained in a laundry basket for containing unwashed clothing articles;
an information detection means for detecting information on a clothing article detected by the article detection section to identify the clothing article; and
a communication means for providing information on the identified clothing article to the clothes washer through communication, and
upon reception of information on the article provided by the laundry basket, the control means of the clothes washer determines whether or not a control program corresponding to the pertinent article is present, and requests the server to download the control program if the control program is not present.

4. The home information appliance system as defined in claim 2, wherein
one of the home electric appliances is a clothes washer,
the clothes washer has:
an article detection section for detecting clothing articles contained in a laundry basket for containing unwashed clothing articles;
an information detection means for detecting information on a clothing article detected by the article detection section to identify the clothing article; and
a communication means for providing information on the identified clothing article to the clothes washer through communication, and
upon reception of information on the article provided by the laundry basket, the control means of the clothes washer determines whether or not a control program corresponding to the pertinent article is present, and requests the server to download the control program if the control program is not present.
